(19) United States
(12) Patent Application Publication
(10) Pub. No.: US 2026/0183713 A1
(43) Pub. Date: Jul. 2, 2026

(54) SIMULTANEOUS ELECTRICITY GENERATION AND LOW-ENERGY-INTENSIVE WATER DESALINATION USING A HYDRAULIC WIND TURBINE

(71) Applicant: Purdue Research Foundation, West Lafayette, IN (US)

(72) Inventors: Helber Antonio Esquivel Puentes, West Lafayette, IN (US); Luciano Castillo, Carmel, IN (US); David Warsinger, Carmel, IN (US); Andrea Vacca, West Lafayette, IN (US)

(21) Appl. No.: 19/549,915

(22) Filed: Feb. 25, 2026

Related U.S. Application Data
(63) Continuation-in-part of application No. PCT/US25/10467, filed on Jan. 6, 2025.
(60) Provisional application No. 63/618,978, filed on Jan. 9, 2024.
(60) Provisional application No. 63/763,128, filed on Feb. 25, 2025.

(51) Int. Cl. B01D 61/06; B01D 61/02; B01D 61/08; B01D 61/12; C02F 1/00; C02F 1/44; C02F 103/08; F03D 9/25; F03D 15/00; F15B 15/18; H02K 7/18

(52) U.S. Cl. CPC B01D 61/06; B01D 61/025; B01D 61/08; B01D 61/12; C02F 1/008; C02F 1/441; F03D 9/25; F03D 15/202; F15B 15/18; H02K 7/183; B01D 2313/243; B01D 2313/246; B01D 2313/367; B01D 2313/701; C02F 2103/08; C02F 2201/009; C02F 2209/40; C02F 2303/10; F05B 2220/706

(57) ABSTRACT

A system capable of simultaneously purifying water and generating electricity includes one or more prime mover, a variable displacement hydraulic pump, a first variable displacement hydraulic motor hydraulically coupled to the variable displacement hydraulic pump, a second variable displacement hydraulic motor hydraulically coupled to the variable displacement hydraulic pump, and a controller having one or more processors adapted to execute software maintained in one or more non-transient memories, the controller adapted to control the pump, the first motor, and the second motor, wherein the first motor output shaft is adapted to be coupled to an electrical generator to thereby generate electricity, and wherein the second motor output shaft is adapted to be coupled to a water purification pump to draw unpure water from a feed supply and provide the unpure water to a water purification system to thereby generate permeated water and separated impurities.

### CROSS-REFERENCE TO RELATED APPLICATIONS

The present non-provisional patent application is a continuation-in-part of International Patent Application PCT/US25/10467, filed Jan. 6, 2025 which is related to and claims the priority benefit of U.S. Provisional Patent Application 63/618,978, filed Jan. 9, 2024, and which is related to and claims the priority benefit of U.S. Provisional Patent Application Ser. 63/763,128, filed Feb. 25, 2025, the contents of which are hereby incorporated by reference in its entirety into the present disclosure.

### STATEMENT REGARDING GOVERNMENT FUNDING

None.

### TECHNICAL FIELD

The present disclosure is related to power generation, and in particular to simultaneous electricity generation and low-energy-intensive water desalination using a hydraulic wind turbine as a prime mover.

### BACKGROUND

This section introduces aspects that may help facilitate a better understanding of the disclosure. Accordingly, these statements are to be read in this light and are not to be understood as admissions about what is or is not prior art.

The increasingly critical issue of water scarcity has a rough forecast showing that by 2040, 33 countries will face a severe water-stressed situation affecting around one billion people. Alongside the potential water shortage, global warming has become another fundamental problem that needs a quick solution. Desalination plants mostly use energy from the grid, which is largely generated using fossil fuels or consume clean water during the process. Electricity generation and water desalination are two critical basic needs that generate a huge portion of the carbon dioxide (CO₂) emissions globally. Electricity generation represents 40% of the total CO₂ emissions worldwide. Wind and solar photovoltaic energies are particularly effective at conserving water compared to nuclear, coal, and natural gas. These conventional power sources consume more scarce water resources for cooling in power plants than is used for agricultural irrigation in the United States of America.

The carbon dioxide emissions for seawater reverse osmosis (RO) desalination has been estimated to range from 0.4 to 6.7 kg CO₂ eq/m³. Therefore, desalinating one million liters of seawater has the potential of generate up to 6.7 tons of CO₂ emissions. Desalination processes generate around 4.4 million tons of CO₂/year due to the use of the electricity generated by plants or electric generators using fossil fuels. Desalination plants that use membrane technologies represent 63% of the total world desalination capacity. A shift of that percentage to renewable energy sources would represent a significant reduction in CO₂ emissions while maintaining water security. Energy consumption of desalination processes depends on feed water salinity, recovery ratio, high-pressure pump efficiency, and energy recovery device efficiency. Considering these parameters, in the specific case of desalinating feed water with a salinity concentration of 35 g/L, the reported energy consumption ranges between 2.5 to 4.5 kWh/m³.

One of the most used renewable energy sources to provide energy to RO systems is energy obtained from solar cell systems. However, solar energy has operational limitations due to the lack of energy during the night or on cloudy days.

Another source of energy is wind power. Notable contributions to the integration of wind energy for water generation have been made. Traditional wind turbines with the mechanical drive-train and generator in the nacelle have been used to power desalination processes. For example, D. Keisar et al. investigates a direct wind-powered desalination system that utilizes a small-scale vertical axis wind turbine to drive reverse osmosis through a high-pressure pump, eliminating the need for electricity generation or a system controller. Through a detailed parametric analysis, the manner in which feed water salinity, load, and wind speed impact system performance, demonstrating high efficiency across varied operating conditions were investigated. The stand-alone system achieved around 13.5% system efficiency and specific energy consumption over a broad range of wind speeds and salinities. With the VAWT's projected area of 0.8 m², the system achieved a permeate output of up to 0.6 m³/day at an average wind speed of 6 m/s. Additionally, J. A. Carta et al. built a small-scale prototype of seawater RO desalination system that adapts its energy consumption in real-time to the power fluctuations provided by the 15 KW wind turbine that powers the process. The energy conversion flow starts from the energy extracted from the wind and its conversion into electricity to finally use an electric motor to convert the electricity into mechanical power to drive the high-pressure pump of the reverse osmosis system, the system includes the use of a frequency inverter, transformers, and an electric regulator. The system has a rated water production capacity of 18 m³/day with an average feed flow rate of 52.08 L/min. The main limitations in this study are related to the low adaptability between the wind turbine power generated and the power consumed by the RO system. Furthermore, P. Cabrera et al. performed a numerical study using machine learning to analyze a wind-powered seawater RO plant prototype. This study provides helpful insight into two common operational modes of the desalination process as a function of the power provided by the wind turbine with and without energy storage. Additionally, G. L. Park et al. studied numerically and experimentally the effect of wind speed fluctuations on the performance of a RO system powered by a wind turbine. Their study considered multiple wind speed profiles and a range of turbulence intensity to impose the effect of the power fluctuations on the numerical analysis and the experimental validation as well. However, further control strategies are required to overcome the intermittent power supply to the RO system, especially while processing high-salinity feed waters. E. Ali proposed a control system that operates continuously in real-time to regulate an RO plant powered by wind energy. The author aimed to control water production hourly based on demand. The study also considered operational constraints like wind power intermittence, flow disturbances, and operation limitations. Their proposed control systems help to reduce the annual water deficit by 20% operating at ideal conditions and by 73% in the case of a shortage.

Therefore, there is an unmet need for a novel hydraulic wind turbine system based on positive displacement machines to power the desalination process and electricity generation with net-zero CO₂ emission in the process.

### SUMMARY

A system capable of simultaneously purifying water and generating electricity is disclosed. The system includes one or more prime mover adapted to provide a rotational movement of a pump output shaft. The system further includes a variable displacement hydraulic pump coupled to the pump output shaft, wherein the variable displacement hydraulic pump controls flow of a fluid from its low-pressure side to its high-pressure side by a pump plate controlled by a pump control signal. Additionally, the system includes a first variable displacement hydraulic motor hydraulically coupled to the variable displacement hydraulic pump, wherein the first variable displacement hydraulic motor controls flow of the fluid from its low-pressure side to its high-pressure side by a first motor plate controlled by a first motor control signal, thus adapted to generate rotational movement of a first motor output shaft. Furthermore, the system includes a second variable displacement hydraulic motor hydraulically coupled to the variable displacement hydraulic pump, wherein the second variable displacement hydraulic motor controls flow of the fluid from its low-pressure side to its high-pressure side by a second motor plate controlled by a second motor control signal, thus adapted to generate rotational movement of a second motor output shaft. The system further includes a controller having one or more processors adapted to execute software maintained in one or more non-transient memories. The controller is adapted to generate a plurality of control signals which includes the pump control signal, the first motor control signal, and the second motor control signal. The first motor output shaft is adapted to be coupled to an electrical generator to thereby generate electricity. The second motor output shaft is adapted to be coupled to a water purification pump to draw unpure water from a feed supply and provide the unpure water to a water purification system to thereby generate permeated water and separated impurities.

A method of simultaneously purifying water and generating electricity is disclosed. The method includes receiving rotational movement from a pump output shaft of one or more prime movers. The method further includes coupling a variable displacement hydraulic pump coupled to the pump output shaft, wherein the variable displacement hydraulic pump controls flow of a fluid from its low-pressure side to its high-pressure side by a pump plate controlled by a pump control signal. Additionally, the method includes hydraulically coupling a first variable displacement hydraulic motor to the variable displacement hydraulic pump, wherein the first variable displacement hydraulic motor controls flow of the fluid from its low-pressure side to its high-pressure side by a first motor plate controlled by a first motor control signal, thus adapted to generate rotational movement of a first motor output shaft. Furthermore, the method includes hydraulically coupling a second variable displacement hydraulic motor to the variable displacement hydraulic pump, wherein the second variable displacement hydraulic motor controls flow of the fluid from its low-pressure side to its high-pressure side by a second motor plate controlled by a second motor control signal, thus adapted to generate rotational movement of a second motor output shaft. Additionally the method includes controlling a plurality of control signals by a controller having one or more processors adapted to execute software maintained in one or more non-transient memories. The plurality of control signals includes the pump control signal, the first motor control signal, and the second motor control signal. The first motor output shaft is adapted to be coupled to an electrical generator to thereby generate electricity. The second motor output shaft is adapted to be coupled to a water purification pump to draw unpure water from a feed supply and provide the unpure water to a water purification system to thereby generate permeated water and separated impurities.

### BRIEF DESCRIPTION OF DRAWINGS

FIG. 1 provides a simplified high-level schematic of a simultaneous water purification and electricity generation system, according to the present disclosure.

FIG. 2A provides schematic of a hydrostatic transmission, according to the present disclosure.

FIG. 2B provides a controller scheme for a simultaneous electrical energy and water purification system, according to the present disclosure.

FIG. 3 provides a complex graph of speed in rpm, and torque in Nm vs. wind turbine rated power in KW.

FIG. 4 provides another block diagram schematic of the system of the present disclosure, depicting the control scheme.

FIG. 5 provides a photograph of the experimental setup of the water purification and electricity generation system, according to the present disclosure.

FIG. 6 provides a graph of normalized wind speed vs. time in seconds, which shows the turbulent wind speed profile used in the system of the present disclosure.

FIG. 7 provides a schematic of energy cascade distribution through a hydrostatic transmission when operating with a feed water salinity of about 35 g/L.

FIG. 8 provides a graph of specific energy consumption and feed pressure as function of the feed water salinity, the tests cover a rage of water salinity from brackish water (5 g/L to 25 g/L) to seawater (30 g/L to 40 g/L), which shows the specific energy consumption and feed pressure as a function of the feed water salinity concentration.

FIG. 9 provides a graph of recovery ratio (RR) and salt rejection ratio vs. feed salinity concentration in

$$\frac{{g}_{NaCl}}{{L}_{{H}_{2} O}} ,$$

which shows the conductivity of the feed and permeate water across a range of feed water salinity concentrations from 5 g/L to 40 g/L.

FIG. 10 provides a graph of normalized flow rate (Q/Qₘₐₓ) vs. normalized pressure (P/Pₘₐₓ) which provides power distribution and power dissipation in the hydrostatic trans-mission operating simultaneously the hydraulic motor driving the high-pressure reverse osmosis (RO) pump and the electric generator at rated conditions, given by the highest salinity that causes the highest load on the RO side of the system of the present disclosure.

FIG. 11 provides a graph of normalized power

$$( \frac{{P}^{′}}{\overline{P}} )$$

vs. time in seconds which shows variations of power at the pump, generator, and hydraulic motor driving the high-pressure pump of the RO system operating at the rated conditions, representing the maximum power consumption by the RO side of the system.

FIG. 12 provides a bar graph of levelized cost of water (LCOW) in ($/m³) and specific energy consumption in KWh/m³ which shows a comparison between desalination methods in terms of specific energy consumption and LCOW per cubic meter of permeate water, including traditional wind turbine with RO, photovoltaic RO, traditional seawater reverse osmosis powered from the grid, the system of the present disclosure, and batch reverse osmosis (BRO) with a feed water salinity concentration of 35±2 g/L.

FIG. 13 provides a graph of experimental flow rate in L per minute vs. feed salinity concentration

$$( \frac{{g}_{NaCl}}{{L}_{{H}_{2} O}} )$$

is provided which shows average flow rate in time.

FIG. 14 provides a graph of experimental pressure in bar vs. feed salinity concentration

$$( \frac{{g}_{NaCl}}{{L}_{{H}_{2} O}} )$$

is provided which shows average pressure in time.

FIG. 15 provides a graph of experimental power in kW vs. feed salinity concentration

$$( \frac{{g}_{NaCl}}{{L}_{{H}_{2} O}} )$$

is provided which shows average power in time.

FIG. 16 provides a graph of experimental power in W vs. time in seconds is provided which shows instantaneous power in time.

FIG. 17 provides a graph of experimental pressure in bar vs. time in seconds is provided which shows instantaneous pressure in time.

FIG. 18 is a corollary figure to FIG. 2B wherein proportionality constants Kₚ, Kᵢ, and K_{d} determined by an artificial intelligence engine, each vary with time.

FIG. 19 is a corollary figure to FIG. 4 wherein proportionality constants Kₚ, Kᵢ, and K_{d} determined by the artificial intelligence engine, each vary with time

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 15%, within 10%, within 5%, or within 1% of a stated value or of a stated limit of a range.

In the present disclosure, the term “substantially” can allow for a degree of variability in a value or range, for example, within 85%, within 90%, within 95%, or within 99% of a stated value or of a stated limit of a range.

A novel hydraulic wind turbine system is disclosed herein that is based on positive displacement machines to power the desalination process and electricity generation with net-zero CO₂ emission in the process. Towards this end, a small-scale test rig, with 3.6 kW rated power, of a hydraulic wind turbine driving an electric generator and simultaneously powering an RO system is presented. A control strategy for the system maintains the output of the generator in a smooth manner to, thereby, provide high power quality. Also, the system operation seeks to keep a stable permeate rate by maintaining the feed flow rate. Using a clean energy source supplies the basic needs of freshwater and electricity with net-zero CO₂ emissions. The system of the present disclosure can be utilized in a multi-scale range.

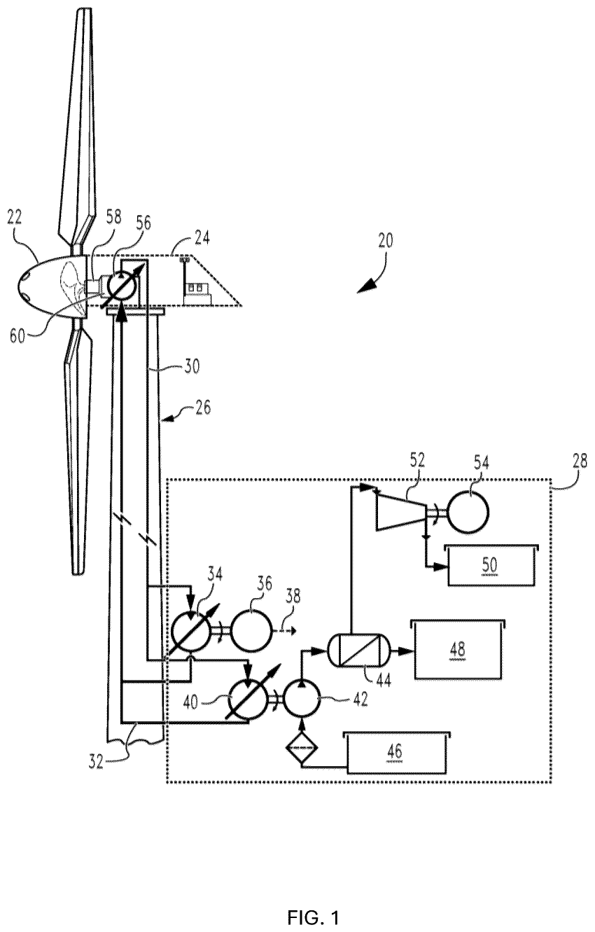

Reference is made to FIG. 1 which includes a simplified high-level schematic of a system 20 of the present disclosure. A wind turbine 22 having a variable displacement hydraulic pump 56 in its nacelle 24 is disposed on a support structure 26, e.g., a tower, is shown. The wind turbine 22 has a drive shaft 58 operationally connected to the input shaft 60 of the variable displacement hydraulic pump 56. Optionally, a gear box or another device, known to a person having ordinary skill in the art, may be disposed between the drive shaft 58 and input shaft 60 so as to allow a gearing up or down between the two shafts as desired. Fluid, e.g., any suitable hydraulic fluid may be used in the system 20 and the nature of such hydraulic fluid may vary depending on location, season, and local weather conditions, from a low-pressure line 32 is pumped up the support structure 26 and into the variable displacement hydraulic pump 56 where it is pressurized and returned via a high-pressure line 30. The exact height of the support structure 26 and length of the low-pressure line 32 and high-pressure line 30 may vary as desired for the specific application in which the system 20 is implemented.

Pressurized fluid is brought by the high-pressure line 30 to a sub-system 28, which is at ground level. While the sub-system 28 is shown at the base of the support structure 26, the sub-system 28 may be located at a distance from a particular wind turbine support structure such that more than one hydraulic wind turbine according to the disclosed invention provides pressurized hydraulic fluid thereto in a parallel manner.

A first variable displacement hydraulic motor 34 is disposed in the sub-system 28 operationally coupled to an electrical generator 36. Pressurized fluid from the high-pressure line 30 drives the first variable displacement hydraulic motor 34 which in turn drives the electrical generator 36 to produce electricity. The produced electricity may exit the sub-system 28 via electrical transmission lines and/or may be used to provide power within the system 20.

A second variable displacement hydraulic motor 40 is disposed in the sub-system 28 operationally connected to a high-pressure pump 42. Pressurized fluid from the high-pressure line 30 drives the variable displacement hydraulic motor 40 which in turn drives the high-pressure pump 42. The high-pressure-pump 42 draws salt water or contaminated water from a feed water source 46 and provides pressurized water to a filtration/purification system 44, e.g., a reverse osmosis (RO) system, but other types of filtration/purification systems are within the ambit of the present disclosure. The water source 46 may be an open body of water (e.g., lake, stream, ocean, and the like), ground water or aquifer, or water stored in tanks or other holding systems. The filtration/purification system 44 generates i) permeated water which is provided to a vessel 48, that is discharged into an existing water system for further treatment, or otherwise distributed as desired, and ii) brine or wastewater that may be stored in a vessel 50 or otherwise suitable disposed of as desired.

Optionally, an energy recovery device (ERD) 52 may extract energy from the pressurized brine prior to storage into the vessel 50 or disposal. The ERD 52 may be operationally coupled to a generator 54 which produces electricity that can be coupled with the energy produced by the electrical generator 36 in parallel and placed on the transmission line 38.

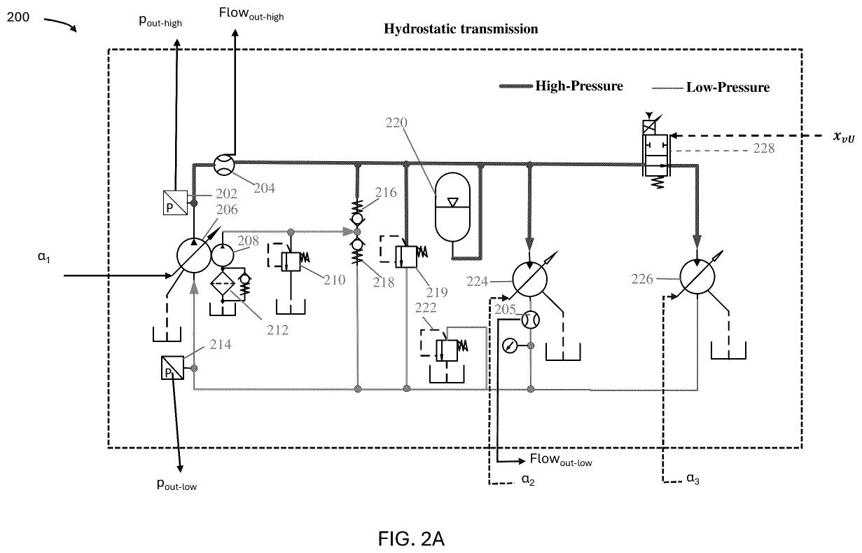

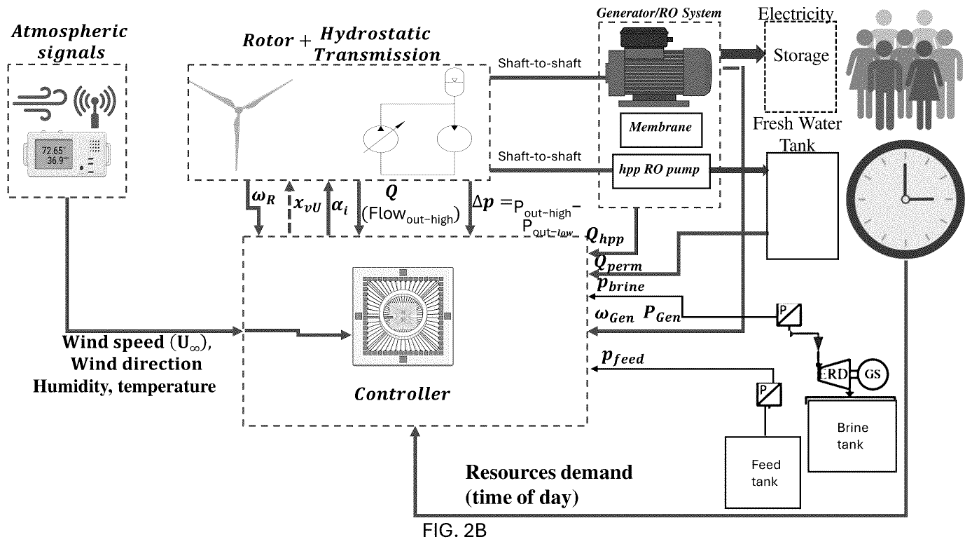

Referring to FIG. 2A, a schematic of a hydrostatic transmission 200 is shown, according to the present disclosure. Table 1 provides a key for various component call-outs.

TABLE 1
Reference call out for FIG. 2A

| Label | Component |
|---|---|
| 202 | High-Pressure Transducer |
| 204 | Flow meter |
| 205 | Flow meter |
| 206 | Variable displacement hydraulic |
| 208 | Charge pump |
| 210 | PRV in the charge circuit |
| 212 | Oil filter |
| 214 | LP pressure transducer |
| 216 | Check valve to the HP line |
| 218 | Check valve to the LP line |
| 219 | Main pressure reducing valve (PRV) |
| 220 | HP line accumulator |
| 222 | LP line PRV |
| 224 | Variable displacement hydraulic motor |
| 226 | Variable displacement hydraulic motor |
| 228 | Proportional throttle valve |

The hydrostatic transmission 200 shown in FIG. 2A is coupled shaft-to-shaft to the turbine 22 (see FIG. 1) which is not shown in FIG. 2A at the variable displacement hydraulic pump 206. Fluid, e.g., hydraulic fluid, is pressurized from a low-pressure side, where its pressure is measured by the LP pressure transducer 214 and pressurized to a high-pressure side, where its pressure is measured by high-pressure transducer 202. The high-pressure side feeds the variable displacement hydraulic motor 224 that is to be coupled to the electrical generator (not shown), and the variable displacement hydraulic motor 226 that is to be coupled to the RO pump (not shown). A proportional throttle valve 228 is also optionally provided. In cases where the turbine is of a low-output type, the proportional throttle valve 228 can be avoided altogether.

The remaining of the components that are called out in Table 1 are not discussed as these are well known by a person having ordinary skill in the art.

The hydrostatic transmission 200 of FIG. 2A is operated by providing certain inputs based on certain outputs. The inputs are: α₁, α₂, α₃, and x_{vU}. α₁, α₂, and α₃ control the swing plate of the variable displacement hydraulic pump 206, and the two variable displacement hydraulic motors 224 and 226, respectively. x_{vU} controls the proportional throttle valve 228. These control signals are sourced by the controller (not shown). To generate these control signals, the controller receives a number of signals from the hydrostatic transmission including p_{out-high} which is a signal commensurate with pressure of the high-pressure side from the high-pressure transducer 202, p_{out-low} which is a signal commensurate with pressure of the low-pressure side from the LP pressure transducer 214, Flow_{out-high} which is a signal commensurate with flow rate of the high-pressure side from the flow meter 204, and Flow_{out-low} which is a signal commensurate with flow rate of the low-pressure side from the flow meter 205.

Referring to FIG. 2B, the controller scheme is further depicted, in which another schematic is shown of a simultaneous electrical energy and water purification system according to the present disclosure is provided. The main input to the system is a wind speed sample. Using the governing equations for energy extraction by the rotor, the electric motor simulating the wind turbine rotor follows the torque estimated from these equations. The main pump is coupled shaft-to-shaft to the prime mover (turbine); then the hydraulic power is split between the two hydraulic motors—one to drive the electric generator and the other to drive the high-pressure pump of the filtration/purification system. FIG. 2B demonstrates how several parameters are used for the hydrostatic transmission and a controller which receives several inputs and produces several outputs to the hydrostatic transmission. Table 2 provides a key for various nomenclature used in FIG. 2B.

TABLE 2
Nomenclature used in FIG. 2B

| Label | Component |
|---|---|
| U_{∞} | free stream wind speed |
| ω_{R} | angular velocity of the rotor |
| x_{vU} | proportional valve control signal |
| αᵢ | control line for variable displacement hydraulic pump and motors |
| Q | Flow_{out-high} from flow meter 204 (FIG. 2A) |
| Δp | p_{out-high} − p_{out-low} |
| Qₕₚₚ | reverse osmosis high-pressure pump flow rate |
| Qₚₑᵣₘ | permeate water volumetric flow rate |
| ω_{gen} | angular velocity of the generator |
| P_{gen} | generator power |
| p_{brine} | pressure of brine |
| p_{feed} | pressure of feed (water to be purified) |

Starting with the turbine, several parameters are sensed and/or calculated: U_{∞} which denotes free stream wind speed, wind direction, humidity, and temperature which are received by the controller. Additionally, ω_{R} which is the angular velocity of the rotor is provided to the controller. The controller also receives Q which is Flow_{out-high} from flow meter 204 (FIG. 2A), Δp which is p_{out-high}-p_{out-low}, Qₕₚₚ which is the reverse osmosis high-pressure pump flow rate, Qₚₑᵣₘ which is the permeate water volumetric flow rate, ω_{gen} which is the angular velocity of the generator, P_{gen} which is generator power (sensed from a power meter or calculated based on torque/RPM and efficiency of the generator, p_{brine} which is the pressure of brine, and P_{feed} which is the pressure of feed. Additionally, the controller receives resource demand, e.g., a schedule of electrical needs per hour of each day.

The controller logic primarily focuses on maximum power extraction from the rotor and maintaining a steady power output by regulating the displacement αᵢ, of the main pump. Regulation on the RO side is carried out by the proportional solenoid valve, which sets the flow rate passing to the hydraulic motor driving the RO high-pressure pump by controlling the opening setting, x_{vU}, of the valve orifice. The basic equations to calculate αᵢ and x_{vU} are provided below.

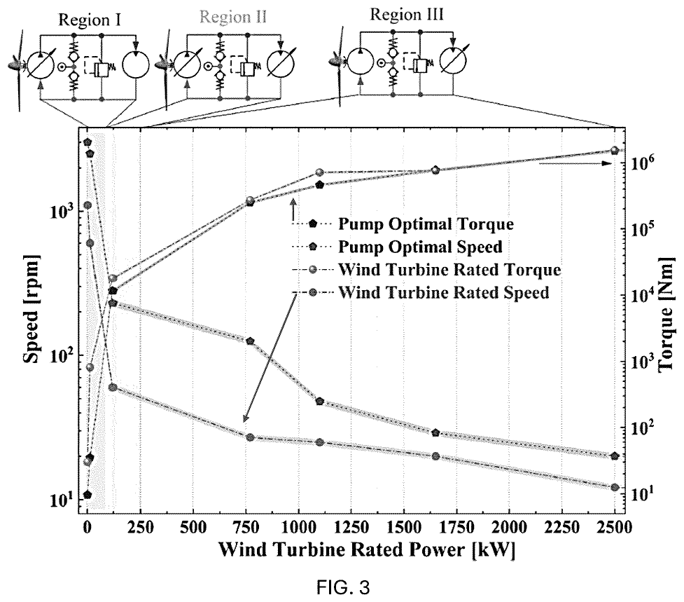

As a design consideration, it is important to reference the size of the prime mover, including the rated power, operating conditions, and availability of commercial units. Energy generation from wind using fluid power is not a very common application; therefore, hydraulic architectures, control strategies, and unit selections are essential factors to consider. To create a self-sustaining system, the wind turbine shaft is coupled to the shaft of the hydraulic unit, allowing the mechanical power harvested by the turbine rotor to be transmitted to the pump shaft and transformed into fluid power, using fluid, e.g., hydraulic fluid, as a working fluid. The present disclosure identifies classification of three architecture regions based on the available power range in the wind turbine rotor, as shown in FIG. 3 which is a complex graph of speed in rpm, and torque in Nm vs. wind turbine rated power in KW. These architecture regions include Region I which denotes turbines capable of generating between 0 and 100 KW, Region II which denotes turbines capable of generating between 100 and 250 KW, and Region III which denotes turbines capable of generating power greater than 250 KW, e.g., between 250 KW and 2500 KW. FIG. 3 provides four graphs: 1) pump optimal torque, 2) pump optimal speed, 3) wind turbine rate torque, and 4) wind turbine rate speed. In short, FIG. 3 provides the main hydraulic architecture regions based on the rated power of the prime mover, primary hydraulic unit, and operating conditions. The three regions are proposed where variable displacement pump, variable displacement motor, or a combination of both are used to maximize the overall efficiency of the systems.

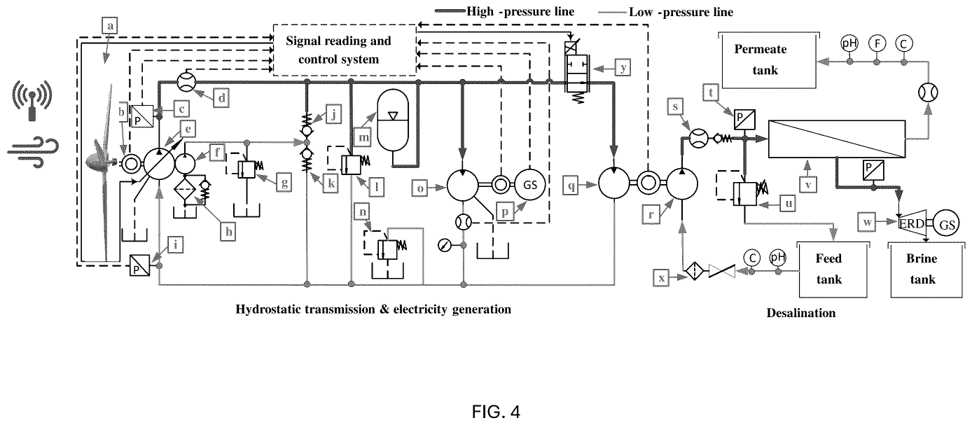

Considering the transmission sizing methodology and design for hydraulic wind turbines, it is found that for very small-scale turbines, using only a variable displacement pump is the main option to regulate the transmission. To control the duty cycle of the RO process, a proportional valve, item y shown in FIG. 4, which is another block diagram schematic of the system of the present disclosure, is used in the high-pressure hydraulic line connected to the flow input port of the hydraulic motor, which drives the high-pressure pump of the RO system. In short, FIG. 4 provides general ISO schematic of the HT fitted to small-scale wind turbines, showing the primary proportional controller and fixed displacement hydraulic motors as outputs used to drive the electric generator and the RO high-pressure pump. The components label here are listed in Table 4, provided below.

Medium-sized wind turbines, in the range of hundreds of kW, can use variable displacement pumps and motors, constrained by the unit market availability. To set the three main hydraulic architectures based on power availability, some parameters must be set by the designer: The high-pressure and low-pressure lines are set at 350 bar and 25 bar, as the most recommended pressure settings for designing closed-circuit hydrostatic transmission (HT); the electric load is set constant by connecting a rheostat to the output of the generator; and the speed setting of the hydraulic motor is 1800 rpm. In the first region considers (Region I), primary proportional control is the outstanding option for small-scale applications. This is because, for small-scale wind turbines, the current commercial hydraulic units allow for variable displacement pumps but constant displacement hydraulic motors, see Table 3, provided below.

TABLE 3
Main hydraulic architecture regions based on the
rated power of the operation conditions of the prime
mover, primary hydraulic unit, and rated power

| | Power range | Rotor Speed range | Pump | Motor |
|---|---|---|---|---|
| Region | [kW] | [rpm] | Displ. | Displ. |
| I | 1-60 | >100 | Variable | Constant |
| II | 90-280 | 50-85 | Variable | Variable |
| III | >250 | <40 | Constant | Variable |

TABLE 4
System components labeled in the hydraulic schematic
in FIG. 4 - this hydraulic architecture corresponds
to small-scale wind turbines as an energy source

| Label | Component |
|---|---|
| a | Wind turbine rotor (Simulated by the electric motor) |
| b | Speed sensor |
| c | High Pressure Transducer |
| d | Flow meter |
| e | Variable displacement hydraulic pump |
| f | Charge pump |
| g | PRV in the charge circuit |
| h | Oil filter |
| i | LP pressure transducer |
| j | Check valve to the HP line |
| k | Check valve to the LP line |
| l | Main PRV |
| m | HP line accumulator |
| n | LP line PRV |
| o | Hydraulic motor |
| p | Electric Generator |
| q | Hydraulic motor |
| r | High-pressure RO pump |
| s | Feed water flow meter |
| t | Feed water line pressure transducer |
| u | Feed water line PRV |
| v | Membrane |
| w | Energy recovery device |
| x | Feed water pre-filter |
| y | Proportional throttle valve |

As discussed above, for the three proposed operation regions, the best option for the system's output is to use axial piston motors. For regions II and III, variable displacement motors are preferred, while for region I, due to the small size of the system, fixed displacement units are the most common. For the pumps, region I can be covered by variable displacement axial piston units. In region II, variable displacement axial piston units are also suitable; however, due to the reduction in the rated angular velocity of the wind turbine, radial piston pumps are the most suitable option, as shown in FIG. 3. Region III is suitable only for radial piston units due to the low-speed, high-torque conditions. For example, for a 1.5 MW wind turbine, a suitable hydraulic unit could be the HAGGLUNDS CBm 3000-2200.

For the present disclosure, the hydraulic architecture described for small wind turbines in the first region was used which is shown in FIG. 3 and in FIG. 4 which show the fluid power circuit according to the ISO standard of representation, including all the components needed to assemble the system that integrates electricity and freshwater generation using a unique, clean energy source. By coupling the wind turbine rotor to the variable displacement pump, the mechanical power is converted into fluid power.

The flow generated is sent through the high-pressure transmission line. In this line, a hydraulic accumulator (see hydraulic accumulator 220 in FIG. 2A) is connected to the system to dampen the pressure fluctuations caused by torque fluctuations from the simulated rotor due to the incoming turbulence. The hydraulic power is then split to run two hydraulic motors: one fraction is used to generate electricity, and the other fraction is used to generate fresh water. The hydraulic motor driving the electric generator converts fluid power into mechanical power. In the scenario of eliminating the frequency inverter from the system and using a generator with a specific number of poles, the angular velocity should be adaptable to deliver the power generated at 60 Hz for the USA and other regions or 50 Hz for places in Europe. The other hydraulic motor driving the high-pressure RO pump is controlled by adding a proportional valve in the high-pressure line to follow the working cycle of the desalination process. The desalination process is carried out by pumping feed water with the high-pressure water pump through the membrane. The separation process occurs inside the membrane, producing permeate water, while brine water is generated as a byproduct. The brine water exits at high pressure, allowing for an energy regeneration process to be performed using an energy recovery device (ERD).

One of the main components of the system of the present disclosure is the hydrostatic transmission which delivers the energy harvested from the wind. The components are sized according to the generator's rated power and the required torque, MG, and is determined according to the methodology for design and sizing of a hydrostatic transmission for wind turbines. The design methodology prioritizes electricity generation since it has more constraints to meet the requirement of delivering electric power at 60 Hz to the grid, avoiding using a frequency inverter. Therefore, in the second priority tier, the operation parameters of the main components of the RO system are more flexible. For instance, the main controller is focused on the maximum power extraction from wind and converting it into electricity as described by equation (1) below.

$${M}_{G} = \frac{{P}_{m}}{{ω}_{G e n} {η}_{G}} \qquad ( 1 )$$

where ω_{Gen} is the angular velocity set at 188.4 rad/s,
η_{G} is the total efficiency of the electric generator, and
Pₘ is the power provided by the hydraulic motor.
   The volumetric displacement of the hydraulic motor Vₘ is estimated using Eq. (2) and the torque demanded to generate the power required.

$${V}_{m} = \frac{{M}_{m}}{Δ p \cdot 2 π \cdot {η}_{m , hm}} \qquad ( 2 )$$

where Mₘ is the torque of the hydraulic motor,
Δp is the delta pressure across the hydraulic motor, and
η_{m,hm} is the hydromechanical efficiency of the motor.
   The flow rate of the transmission under nominal conditions is estimated as following:

$${Q}_{i} = \frac{{ω}_{m} {V}_{m} α}{{η}_{m , v}} \qquad ( 3 )$$

where ωₘ, is the angular velocity of the motor,
θ_{m,v} is the volumetric efficiency of the hydraulic motor, and
α is the displacement setting of the motor.
   The hydrostatic transmission used to transfer the power from the prime mover to the electricity and water generation outputs includes a variable displacement axial piston pump. The transmission drives two rotatory actuators. The prime mover of the test rig is an electric motor of 15 HP that simulates the rotor of the wind turbine. The conversion from mechanical power into fluid power is carried out by the variable displacement axial piston pump with a maximum displacement of 18 cc/rev, which was the smallest variable piston pump in the market with proportional solenoid electrically controlled, but also in the power range considered for this study. The proportional controller keeps the pump working in the first quadrant. A 5 cc/rev bent-axis piston motor drives the electric generator. A gerotor of 7 cc/rev drives the high-pressure pump of the RO system. A 1 L piston accumulator is integrated with the high-pressure line of the hydrostatic transmission with the aim of damping the pressure fluctuations and short-term energy storage. The maximum pressure in the high-pressure line is set by the maximum cracking pressure of the main pressure relief valve (i) at 120 bar. The maximum pressure in the low-pressure line is set by the maximum cracking pressure of the pressure relief valve (n) in that line at 25 bar. Table 3 lists the properties of the oil used in the HT.

The hydraulic motor that serves as output of the hydrostatic transmission is coupled shaft-to-shaft with a 3 HP electric generator. The load applied to this electric generator is given by a constant resistor. The voltage is measured using a voltage divider array, and the current is measured using a Hall-effect current sensor with a rated current of 30 A. These sensors are connected to the DAQ to measure and collect the data generated. The components of the actual cyber-physical system are listed in Table 4. An important component for continuous operation is the oil cooler. To estimate the size of this component, the following equation is used:

$${P}_{s} = {P}_{i} ( 1 - ( {η}_{m , v t o t , p} \cdot {η}_{m , t o t , m v} ) ) + ( {Q}_{OR} \cdot Δ {P}_{OR} ) \qquad ( 4 )$$

where P_{S} is the dissipated power,
Pᵢ is the required power,
η_{tot,p} is the total efficiency of the pump,
η_{tot,m} is the total efficiency of the hydraulic motors used,
Q_{OR} is the flow rate that passes through the valve orifice, and
ΔP_{OR} is the pressure drop across the valve orifice.
   Once the power dissipated is estimated, that value is used to size the cooler use to keep the oil in ideal operation temperature. In this case at rated conditions the maximum power dissipated that goes into heat generation is around 372 W at rated operating conditions.

As discussed above, the power generated from the wind turbine is first converted to hydraulic power and then the hydraulic power is split between water purification and electrical energy generation. The hydraulic power split is conducted to keep the electric generator at approximately constant speed. This helps maintain consistent pressure buildup inside the membrane and avoid backflow when the high-pressure pump decelerates or slows down. This operational condition aims to provide hydraulic power to overcome the osmotic pressure in freshwater generation and maximize the water flow generated by the high-pressure pump. To achieve this, the primary controllers adjust the electric solenoid of the pump to change the gear ratio, ensuring as stable electricity generation as possible.

A proportional valve installed in the high-pressure line coupled to the inlet port of the rotor controls the flow rate to this unit, which is coupled shaft-to-shaft with the RO high-pressure pump. For the small-scale case study validated using the cyber-physical system, electricity and water generation synchronization is achieved by splitting the flow generated by the pump coupled to the wind turbine's rotor.

$$\frac{d {ω}_{R}}{d t} = \frac{1}{{J}_{R}} ( {M}_{R} - {M}_{P} ) \qquad ( 5 )$$

where J_{R} is the moment of inertia of the rotor,
M_{R} is the torque provided by the prime mover, and
Mₚ is the pump torque.
   To control the effect of wind speed fluctuations and improve the power quality generated by the hydraulic wind turbine, the control strategy carefully includes the direct coupling of the hydraulic motor to the high-pressure water pump. This strategy must consider that the output torque from the hydraulic motor is directly related to the pressure in the RO section, which is also influenced by the feed flow rate.

$$\frac{d {ω}_{m}}{d t} = \frac{1}{{J}_{R m}} [ ( \frac{Δ p {V}_{m}}{20 π} - {M}_{{S}_{m}} ) - ( \frac{( \frac{{J}_{w}}{{A}_{w}} + {Δπ}_{R O} ) \cdot {V}_{RO , hpp}}{20 π} - {M}_{{S}_{RO , hpp}} ) ] \qquad ( 6 )$$

where M_{S}_{ₘ} are the torque losses in the hydraulic motor driving the RO pump,
M_{S}_{_{RO,hpp}} are the torque losses of the RO high-pressure pump,
V_{RO,hpp} is the volumetric displacement of the RO high-pressure pump,
A_{w} is the membrane permeability coefficient,
π_{RO} is the term for the osmotic pressure, and
J_{w} is the mass flux of water through the membrane.
   The opposing torque generated by the high-pressure pump (hpp) depends on the piston pump's salinity dynamics and torque losses. The parameter to control the RO cycle is determined by the flow rate that passes through the hydraulic motor driving the RO hpp pump. Due to the size of the test rig in this study, the authors used a dissipative controller, employing a proportional valve to control the flow rate sent by the main pump to the hydraulic motor coupled shaft-to-shaft with the high-pressure RO pump. This flow rate Q_{OR} is determined using the following equation:

$${Q}_{OR} = {C}_{f} {Ω}_{0} {x}_{v} \sqrt{\frac{2 Δ p}{ρ}} \qquad ( 7 )$$

where xᵥ is the valve opening setting,
C_{f} is the orifice coefficient,
Ω₀ is the orifice area, and
ρ is the oil density. This valve opening setting is modeled as follows:

$${x}_{v} ( s ) = \frac{1}{1 + S {τ}_{v}} \cdot {x}_{v U} ( s ) \qquad ( 8 )$$

where x_{vU}(s) is the valve control signal discussed above coming from the controller.
   The characteristic time ty of the transfer function is constrained by the turbulence intensity of the wind speed sample used as input and the time response of the valve used in the cyber-physical system. The offset used for the valve controller is the valve opening setting that allows the flow rate needed to achieve the rated angular velocity of the hpp, ensuring continuous water flow generation to be pumped to the membrane of the RO system.

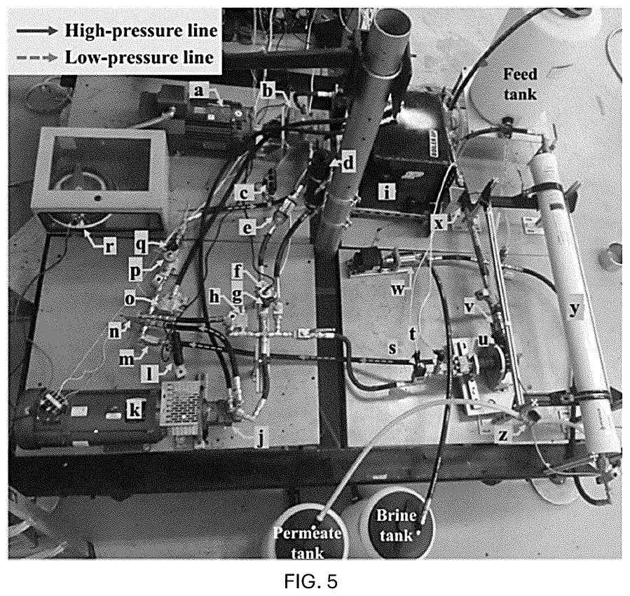

The desalination process to provide fresh water is carried out by continuous RO. In this method, the feed water is pumped by the high-pressure pump to pass through the membrane where the separation process occurs. For this case study, the authors have considered the hydraulic architecture of the first size range presented in the previous section. The continuous RO system includes a high-pressure pump with a 2.2 cc/rev displacement and a feed water tank. The maximum pressure setting in the system is 66 bar, according to one non-limiting embodiment, regulated by the pressure relief valve upstream of the membrane in the high-pressure line, as shown in FIG. 5.

The power requirement for the RO system can be estimated based on the torque required by the high-pressure pump to overcome the osmotic pressure. Assuming a constant flow rate, the pressure downstream of the main RO pump is the main parameter for calculating energy consumption. The rated flow rate is used to estimate the maximum power requested by the RO system. The rated power requirement for the RO high-pressure pump can be estimated by computing the rated flow rate of 3 L/min at the maximum pressure of 66 bar, resulting in 326 W.

The flow rate downstream of the high-pressure pump is measured using an ultrasonic flow meter, part x in FIG. 5, and the permeate water downstream of the membrane is also measured with another flow meter. Using the continuity approach, the brine flow rate is estimated. The mass flux of water through the membrane depends directly on the osmotic pressure and the applied hydraulic pressure generated due to the salinity in the feed water. These parameters can be estimated as follows:

$${J}_{w} = {A}_{w} ( Δ {P}_{R O} - Δ {π}_{R O} ) \qquad ( 9 )$$

where Aw is the membrane permeability coefficient, set at 1.16/3600×10⁻³ [m/s-bar], ΔP_{RO} is the pressure buildup in the high-pressure line that connects the output of the hpp pump to the membrane, and Δπ_{RO} is the osmotic pressure. The power PCRO consumed by the RO high-pressure pump can be estimated as follows:

$${P}_{GRO} = \frac{{Q}_{feed} \cdot {P}_{hpp}}{{η}_{hpp}} + {P}_{{m}_{1}} \cdot ( a - {η}_{tot , {m}_{1}} ) + ( {P}_{p} \cdot ( 1 - {η}_{tot , p} ) \cdot 0.24 ) - {P}_{ERD} \qquad ( 10 )$$

where Q_{feed} is the flow rate generated by the hpp pump,
Pₕₚₚ is the high pressure value downstream the hpp pump,
ηₕₚₚ is the total efficiency of the pump,
Pₚ is the power at the main pump,
η_{tot,p} is the total efficiency of the main pump,
Pₘ_{₁} is the power of the hydraulic motor driving the RO hpp,
η_{tot,m}_{₁} is the total efficiency of the hydraulic motor, and
P_{ERD} is the power recovered by the ERD.
   At rated conditions the Power that finally consumes the continuous reverse osmosis is a fraction of the total fluid power available, since 24% of the power is used by the RO system. The specific energy consumption (SEC) is determined by:

$$SE {C}_{GRO} = \frac{{\dot{W}}_{hpp}}{{Q}_{perm}} \qquad ( 11 )$$

where \dot{W}ₕₚₚ is the power required by the high-pressure RO pump, and
Qₚₑᵣₘ is the flow rate of freshwater obtained downstream the membrane.
   Locally, the power required by the reverse osmosis system is equal to QP/η. However, for a fair comparison with other desalination methods, all power losses across the energy conversion stages are included in P_{CRO}. The parameters of the water used during the experiments are listed in Table 5.

TABLE 5
Initial values of the feed water at
the feed tank used in the RO system.

| Symbol | Description | Units | Value |
|---|---|---|---|
| Tfeed | Temperature feed water | [° C.] | 25 |
| pfeed | Rated Pressure feed water | [bar] | 66 |
| Qfeed | Rated Flow rate feed water | [L/min] | 3.68 |
| Cfeed | Salt concentration feed | [g/L] | 5-40 |
| | water | | |

The instantaneous recovery ratio can be estimated by computing the signal from the flow rate sensor downstream of the pump and the flow rate sensor after the membrane measures the permeate water. By considering the continuity of the water being pumped by the hpp and the permeate water, the instantaneous recovery ratio RR can be estimated as follows:

$$R R = \frac{{Q}_{perm}}{{Q}_{hpp}} \qquad ( 12 )$$

where Qₚₑᵣₘ is the permeate water volumetric flow rate, and
Qₕₚₚ is the feed water volumetric flow rate generated by the reverse osmosis high-pressure pump.

The separation process in the membrane pushes water molecules through the membrane, obtaining pure water downstream at atmospheric pressure. The concentrated brine is evacuated from the mem-brane at high pressure, which depends on the feed salinity, around 66 bar for a feed salinity of 35 g/L. The brine flow at high pressure provides hydraulic power that can be recovered. Hydraulic power can be converted into electricity by using a hydraulic unit coupled with a shaft-to-shaft to an electric generator. Another configuration involves coupling the high-pressure pump to the hydraulic energy recovery unit to provide part of the power demanded by the hpp. For this study, the authors consider the first configuration mentioned, using an axial piston motor coupled shaft-to-shaft to a DC electric generator.

The logic to size the energy recovery device considers the maximum pressure of the brine flow coming out from the membrane and the rated flow rate based on the recovery ratio of the process, which in this case is 50%. To select the appropriate ERD, the pressure at the inlet port of the unit must be considered when looking at available hydraulic machines on the market. Additionally, the rated flow rate and the materials used to manufacture the unit must resist high current densities due to the high salt concentration of the working fluid.

$${V}_{ERD} = \frac{( {Q}_{hpp} \cdot ( 1 - RR ) ) \cdot {η}_{ERD , v}}{{ω}_{ERD}} \qquad ( 13 )$$

where ω_{ERD} is given by the rated speed of the electric generator coupled shaft-to-shaft to the energy recovery device,
η_{ERD,v} is the overall efficiency of the energy recovery device.

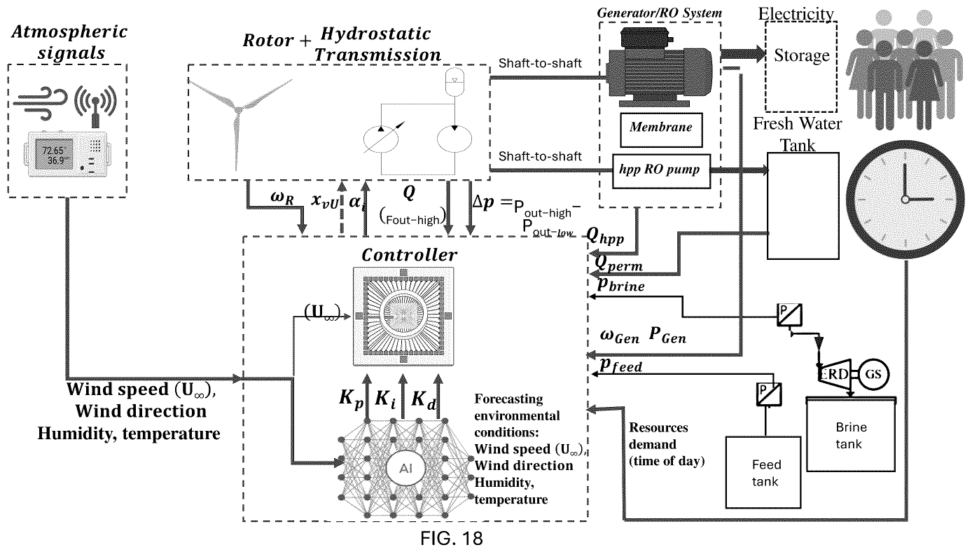

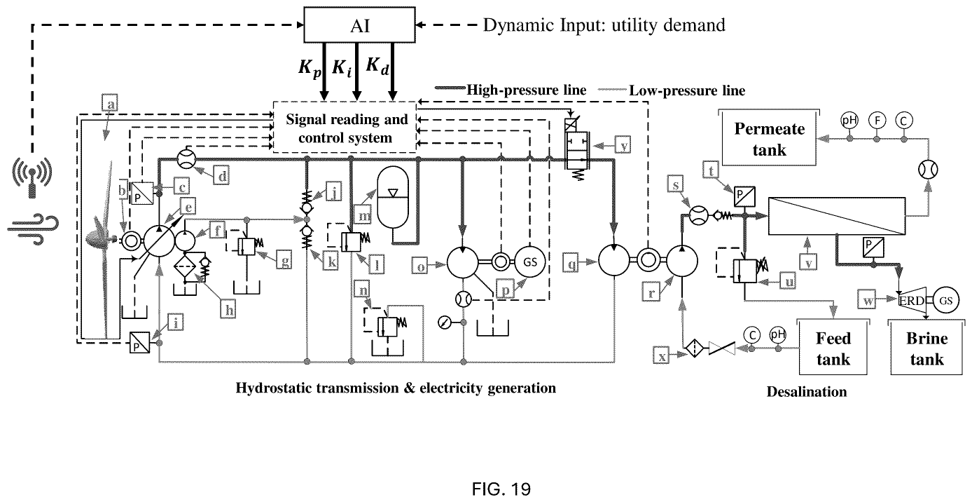

The terms αᵢ (i.e., α₁ which controls the plate of the variable displacement hydraulic pump 206 (see FIG. 2A), α₂ which controls the plate of the variable displacement hydraulic motor 224 (see FIG. 2A), and α₃ which controls the plate of the variable displacement hydraulic motor 226 (see FIG. 2A)) are determined based on the generic formula:

$$u ( t ) = {K}_{p} e ( t ) + {K}_{i} {\int }_{0}^{t} e ( τ ) d τ + {K}_{d} \frac{d e ( t )}{d t} \qquad ( 14 )$$

where u(t) is a parameter to be determined (e.g., αᵢ(t)),
e(t) is the error between the actual parameter value and the desired parameter value, and
τ is a time constant.
   With reference to FIGS. 2A, 2B, and 4, Kₚ, Kᵢ, and K_{d} are all constants, however, with regards to FIGS. 18 and 19, discussed further below, which are corollary figures to FIG. 2B and FIG. 4, respectively, Kₚ, Kᵢ, and K_{d} each vary with time. The proportionality constants Kₚ, Kᵢ, and K_{d} are determined based on derivations found in Table 6, provided below. It should be noted that the parameter for which e(t) is determined can be several different parameters. For example, for a wind turbine as the prime mover e(t) can be wind speed (U_{∞}), angular velocity of the rotor (ω_{R}). However, other parameters are within the ambit of the present disclosure. For example, suppose the prime mover is an internal combustion engine, then e(t) can be angular velocity of the output shaft.

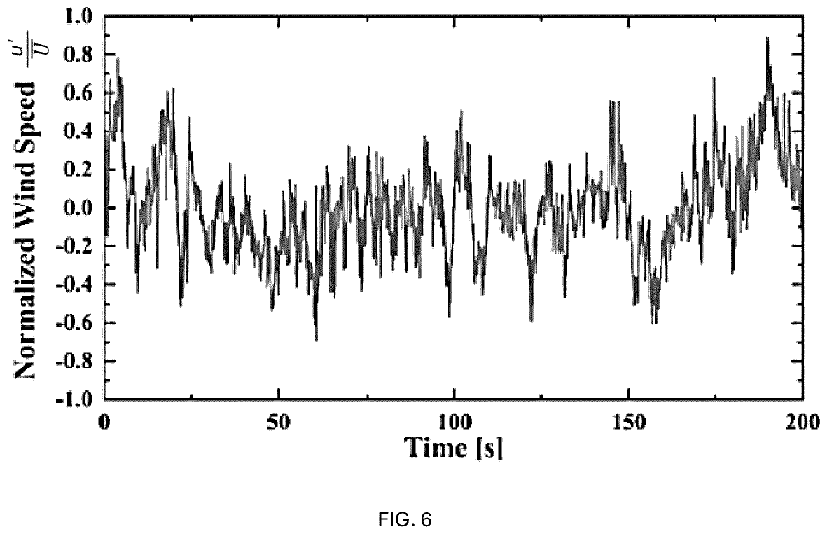

The experimental cyber-physical system used to validate the hypothesis of water desalination and electricity generation by using the concept of the hydraulic wind turbine is shown in FIG. 5, which is a photograph of the experimental setup according to the present disclosure. The rotor of the wind turbine has been simulated by the electric motor, part a in FIG. 5, and serves as the prime mover of the main hydraulic pump. Using the wind energy extraction governing equations, the torque provided by the wind turbine's rotor to the hydraulic pump is calculated, for which the rotor inertia is also included. This torque profile is used as a variable frequency driver programming parameter. FIG. 6, which is a graph of normalized wind speed vs. time in seconds, shows the turbulent wind speed profile used. This instantaneous velocity signal is normalized with the average velocity U. One of the hydraulic motors, part j in FIG. 5, is coupled shaft-to-shaft with the electric generator, which maintains a constant load provided by a rheostat. The second hydraulic motor of the HT, part u in FIG. 5, is coupled shaft-to-shaft with the high-pressure water pump of the RO system. The salinity in the feed water pumped through the membrane determines the load on this side. The main pressure relief valve, part h, is used to interconnect the high and low-pressure lines. The cracking pressure of this valve is set at 120 bar, allowing the system pressure increases up to this value. In the low-pressure line of the closed system, the cracking pressure of the pressure relief valve, part o, is set to 25 bar.

The system has two power outputs: one that converts the fluid power into mechanical power to drive the electric generator and the other that drives the RO system's high-pressure pump. The second power output uses the fluid power converted into mechanical power to drive the electric generator. The part-load operation is regulated by the controllers, taking into account the input used and the induced fluctuations from the prime mover to the main hydraulic pump. The displacement control of the pump ensures real-time adjustments to compensate for varying wind speed inputs, focusing on optimizing the power output of the generator. At the reverse osmosis site, the controller in the proportional valve aims to maintain the flow rate as steady as possible, close to the flow rate that maximizes the feed water flow generated by the high-pressure pump (hpp), which is coupled shaft-to-shaft with Hydraulic Motor 1, as shown in FIG. 2B.

All signals from the pressure, flow rate, speed, and power sensors are collected by the data acquisition system. The interface to save the generated data and control the displacement of the main hydraulic pump of the system is created using Lab VIEW, including the two data acquisition signal inputs and outputs. The power demanded by the desalination process is determined by computing the pressure down-stream of the high-pressure pump based on the measured feed flow rate. The salinity concentrations tested were in the range from 5 g/L to 40 g/L. Salinity reduction is determined by measuring the electric conductivity at the feed and permeate tank to quantify and correlate the salinity concentration versus power consumption.

The salinity concentration in the feed and permeate water was measured using a conductivity probe (Atlas Environment K 1.0). The percentage error for the probe ranged between 0.9% and 4% for the ranges tested during the experiments. Conductivity in the permeate water is measured immediately after it exits the membrane to obtain accurate measurements. This is because CO₂ in the atmosphere will continuously dissolve in the permeate water, forming highly conductive carbonate ions, thereby altering the conductivity measurement of the filtered water.

The effects of wind flow turbulence are mitigated by adjusting the displacement of the pump to maintain maximum power extraction, adhering to the tip speed ratio that maximizes the power coefficient. Also, the accumulator effectively filters out fluctuations induced by the turbulent wind speed sample used as the system input. The results indicate that the system can provide stable and sufficient power across a broad range of salinities, from brackish water to seawater, while simultaneously generating electricity. This demonstrates the system's robustness and versatility in handling varying salinity levels while maintaining consistent power output.

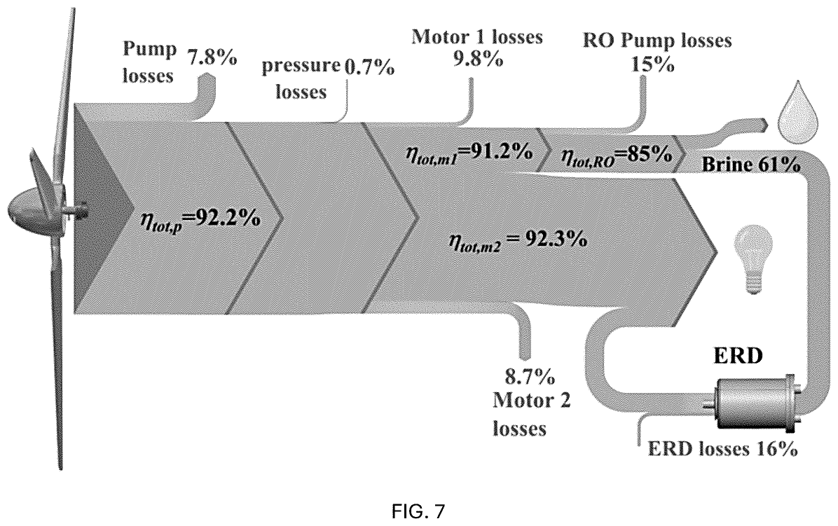

To quantify the specific energy consumption of the RO system powered by the hydraulic wind turbine, the most impactful energy losses in transmitting power from the prime mover to the high-pressure pump are considered. In the hydrostatic transmission, the main energy losses occur in the hydraulic units, so friction and volumetric losses are accounted for by including the hydromechanical and volumetric efficiencies of the pump and motors, as shown in FIG. 7 which is a schematic of energy cascade distribution through the hydrostatic transmission when operating with a feed water salinity of about 35 g/L.

Empirical losses are characterized for each unit, as they depend on angular velocity and pressure. The volumetric and hydromechanical losses are determined experimentally from an 18 cc/rev hydraulic unit. These losses are scaled down for motors with smaller volumetric displacement to match the size estimated during the system design. Also, the overall efficiency of the high-pressure RO pump, as provided by the manufacturer, is taken into account. Energy recovery from the brine at high pressure is converted into electricity, as shown in FIG. 7.

The estimation of losses presented is obtained for a specific case where the feed water has a salt concentration of 35 g/L. The energy recovery ratio decreases progressively for lower salt concentrations while the recovery ratio increases proportionally/

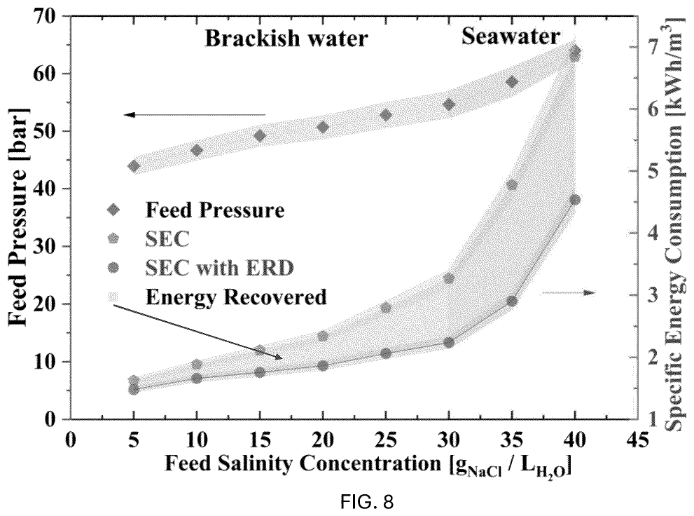

FIG. 8, which is a graph of specific energy consumption and feed pressure as function of the feed water salinity, the tests cover a rage of water salinity from brackish water (5 g/L to 25 g/L) to seawater (30 g/L to 40 g/L), shows the specific energy consumption and feed pressure as a function of the feed water salinity concentration. The first range of salinity concentration, from 5 g/L to 25 g/L, is considered brackish water. The specific energy consumption obtained without using the ERD ranged from 1.6 kWh/m³ to 2.7 kWh/m³ for desalinating brackish water. For this salinity range, the specific energy consumption using the hydraulic wind turbines appears lower than other renewable energy methods for desalination. The proposed architecture in this study achieves a 42% reduction in specific energy consumption for a feed con-centration of around 5 g/L compared to the configuration reported by prior art.

The second range, considered seawater due to its salinity from 30 g/L to 40 g/L, shows specific energy consumption from 3.2 kWh/m³ to 6.8 kWh/m³. For both salinity ranges, the specific energy consumption was lower than that of other desalination technologies and energy sources. Moreover, when the energy recovery device (ERD) is engaged, a notable reduction in specific energy consumption is observed, directly related to the recovery ratio.

It is observed that the amount of brine water is higher for high salinity water, resulting in a higher flow rate at high pressure compared to low salinity water. This results in a proportional reduction in specific energy consumption by converting the hydraulic power of the brine into electricity and feeding it back into the system, thus reducing the energy demand from the prime mover for water desalination. Specifically, a reduction of up to 39% is achieved for 40 g/L salinity with a recovery ratio of 28%, due to the highest amount of high-pressure brine flow being directed to the ERD.

Reducing specific energy consumption can be correlated with the lower energy-intensive process since fewer energy conversion stages are part of the presented design compared to traditional wind turbine con-figurations. In the traditional setup, the kinetic energy from the wind is converted at the top into mechanical power, then into electric power by the main generator in the nacelle, and finally sent to the bottom of the wind turbine where an electric motor drives the high-pressure pump. In contrast, the fluid power technology used in this study provides a higher power-to-weight ratio, offering significant technical and economic benefits, especially for offshore wind turbines, aimed at powering electricity and desalination generation.

The average feed pressure for the range of feed salinity showed a continuous increase from 43 bar to 64 bar. The standard deviation in the collected data increased with salinity, which was related to the pressure build-up inside the membrane. Although there is a consistent increasing pattern, the pressure is also affected by the pores in the membrane, which randomly become saturated as salinity concentration increases. This is reflected in a fluctuating water flux J_{w}, slightly impacting the stability of the RO high-pressure pump. Consequently, the system operates very stably and smoothly at low salinity, while at high salinity and pressure settings, the high-pressure pump experiences more variable operating conditions. When comparing wind energy transmitted by hydrostatic transmission to other renewable and traditional energy sources, it is evident that net-zero emissions are achieved while simultaneously generating freshwater and electricity. In contrast, grid-powered desalination plants generate 2.8 kg-CO₂/m³ of water. Furthermore, by reducing the number of components needed through fluid power to configure the system, the amount of CO₂ generated in fabricating those components is also qualitatively reduced.

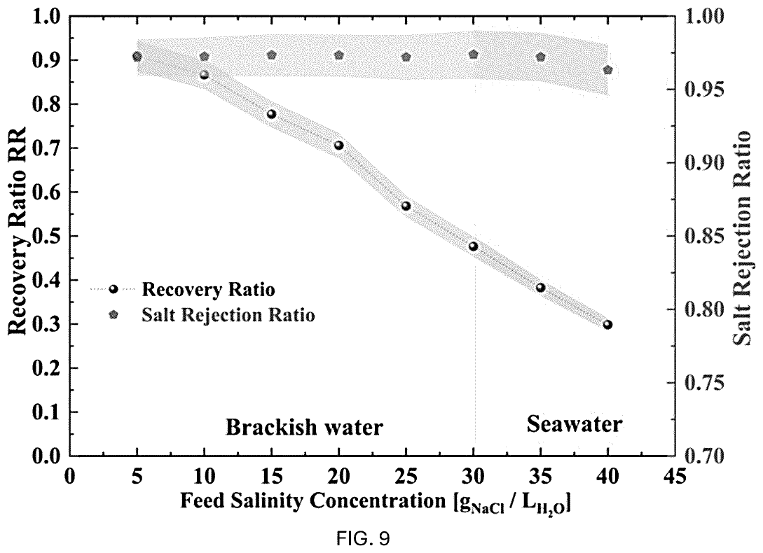

FIG. 9, which is a graph of recovery ratio (RR) and salt rejection ratio vs. feed salinity concentration in

$$\frac{{g}_{NaCl}}{{L}_{{H}_{2} O}} ,$$

shows the conductivity of the feed and permeate water across a range of feed water salinity concentrations from 5 g/L to 40 g/L. This range includes brackish water from 5 g/L to 30 g/L and seawater from 30 g/L to 40 g/L, with electric conductivity from 9521 μs/cm to 50,131 μs/cm. The permeate water samples have an electric conductivity from 363 μs/cm to 1847 μs/cm for the eight feed salinity concentrations.

The reduction in conductivity in the permeate water compared to the feed water indicates effective desalination [37], which is powered by the energy extracted from wind and transmitted by hydrostatic trans-mission. The reduction in water conductivity in the permeate water demonstrates the system's capability to desalinate a broad range of salinity concentrations. This capability suggests that the hydraulic wind turbine system can benefit regions globally where wind resources are available and access to brackish and seawater.

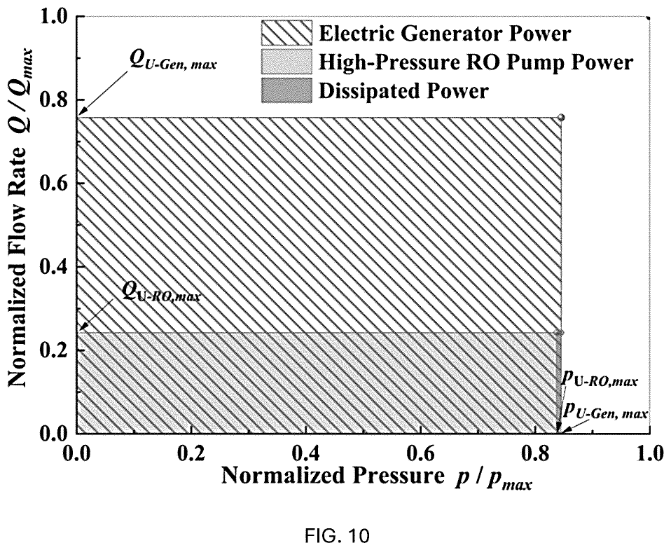

FIG. 10, which is a graph of normalized flow rate (Q/Qₘₐₓ) vs. normalized pressure (P/Pₘₐₓ) provides power distribution and power dissipation in the hydrostatic trans-mission operating simultaneously the hydraulic motor driving the high-pressure RO pump and the electric generator at rated conditions, given by the highest salinity that causes the highest load on the RO side of the system. The figure shows the proportion of the power split between the two actuators at rated load conditions given by a feed water salinity of 40 g/L. The maximum power consumption by the desalination system reaches 24% of the total power provided by the prime mover, resulting in 76% of the power being used for electricity generation. This ratio is determined based on the size of the hydraulic motors used to drive either the electric generator or the high-pressure water pump. Also, the figure illustrates the proportion of power dissipation by the proportional valve responsible for regulating the flow to the hydraulic motor driving the RO-hpp pump. At rated conditions, with the highest salinity tested, the power dissipation in this valve was 0.46% of the total useful power of the system. It has been observed that the salt concentration in the feed water affects the pressure in the RO system and, consequently, the torque demanded by the high-pressure pump (hpp), which must be supplied by the hydraulic motor of the hydraulic wind turbine. The increase in pressure as a function of increased salinity immediately affects the torque required by the hpp. This, in turn, influences the dynamics of the shaft-to-shaft coupling with the hydraulic motor, a part of the hydro-static transmission. For this scale, the dissipative control provided by the proportional valve helps the transmission mitigate the impact of dynamic pressure increases on the RO coupling side, thereby preventing adverse effects on the main electric generator.

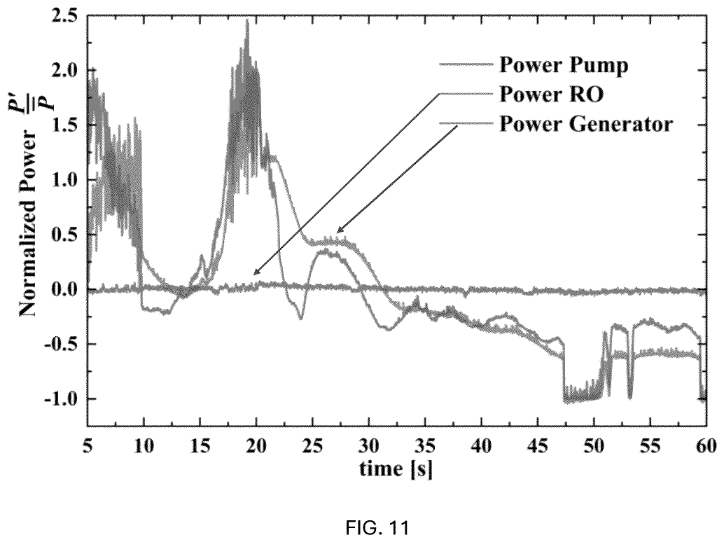

FIG. 11, which is a graph of normalized power

$$( \frac{{P}^{′}}{\overline{P}} ) vs .$$

time in seconds provides variations of power at the pump, generator, and hydraulic motor driving the high-pressure pump of the RO system operating at the rated conditions. The electric generator power shows a quasi-stable signal for most of the sampling time. Some disturbances that the controller struggles to overcome are observed at 5 s to 10 s and 17 s to 23 s, which can be attributed to the fast acceleration and deceleration from the input signal. After this transient period, the power signal presents a smooth behavior compared to the input wind speed profile. Without any regulation, it tends to follow the fluctuations in the wind speed profile.

The hydraulic power at the gerotor driving the hpp exhibits a generally flat trend but also presents fluctuations with a small amplitude caused by the action of the proportional valve. These fluctuations can be correlated to the input used in the prime mover and are more noticeable in the flux through the membrane (J_{w}) as the feed salinity progressively increases. This affects the pressure buildup downstream of the hpp, resulting in fluctuating opposing torque on the gerotor, causing variations in ωₕₚₚ. For lower values of feed salinity, the fluctuations are proportionally smaller.

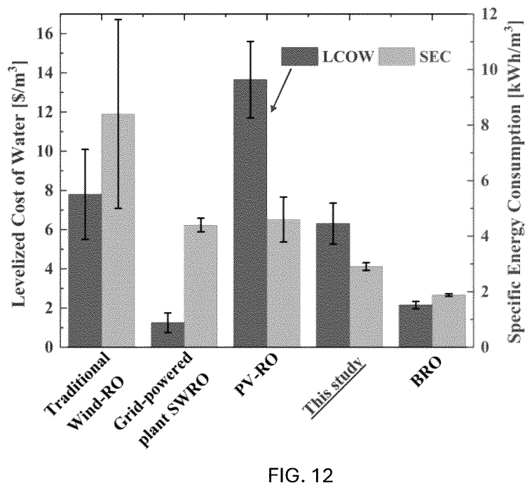

After characterizing the specific energy consumption (SEC) of operating the cyber-physical system across a broad range of feed water salinity concentrations, a particular case of seawater with a concentration of 35 g/L was used for comparison with other desalination system architectures, as shown in FIG. 12, which is a bar graph of levelized cost of water (LCOW) in ($/m³) and specific energy consumption in KWh/m³ provides a comparison between desalination methods in terms of specific energy consumption and LCOW per cubic meter of permeate water, including traditional wind turbine with RO, photovoltaic RO, traditional seawater reverse osmosis powered from the grid, the system of the present disclosure, and batch reverse osmosis (BRO), with a feed water salinity concentration of 35±2 g/L. By transmitting wind energy via hydrostatic transmission and engaging the ERD at the brine line of the RO system, the proposed system achieves up to a 65% reduction in SEC compared to RO powered by a traditional wind turbine.

Changing the traditional mechanical and electric array to transmit power using the hydraulic wind turbine concept reduces the number of energy conversion stages, making the desalination process less energy-intensive. Moreover, as shown in the techno-economic analysis presented in prior work, the hydraulic wind turbine concept saves installation and maintenance, making the process less expensive and more competitive with other desalination methods.

The hydraulic architecture presented above effectively transmits the energy harvested from wind by the prime mover—simulated here by an electric motor—which is converted into fluid power and then delivered as flow rate and pressure to the hydraulic motor output. This design involves two energy conversion stages from input to output, representing a significant reduction compared to traditional wind tur-bines or photovoltaic systems.

Comparing a particular case that uses electricity generated by solar panels to power the electric motor driving the desalination high-pressure pump, the proposed system in this study achieves a 37% reduction in SEC. Furthermore, traditional seawater RO desalination plants, such as the one in North Africa, could see a 34% reduction in SEC compared to the hydraulic wind turbine system. These traditional desalination plants, powered by grid electricity, have a carbon footprint of 0.4-6.7 kg CO₂ eq/m³.

The concept presented is a key player in lowering the energy demand per cubic meter of water compared to the batch reverse osmosis (BRO) desalination method, which is one of the least energy-intensive architectures, theoretically consuming 35% less energy than the presented design. Renewable wind energy generates net-zero emissions while producing fresh water and electricity. Also, by reducing the number of components needed through fluid power, the amount of CO₂ generated while fabricating those components is also qualitatively reduced.

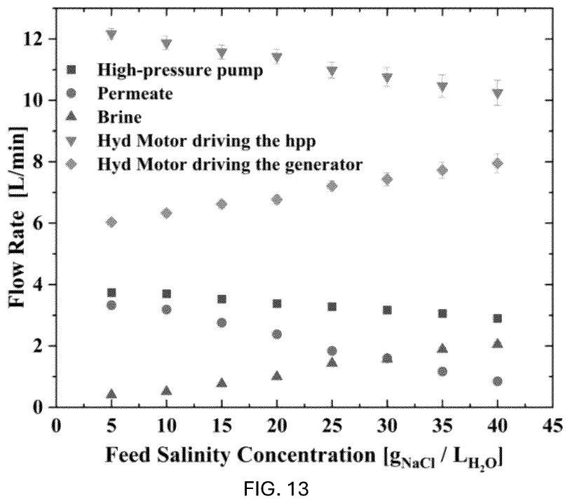

Referring to FIG. 13 a graph of experimental flow rate in L per minute vs. feed salinity concentration

$$( \frac{{g}_{NaCl}}{{L}_{{H}_{2} O}} )$$

is provided which shows average flow rate in time.

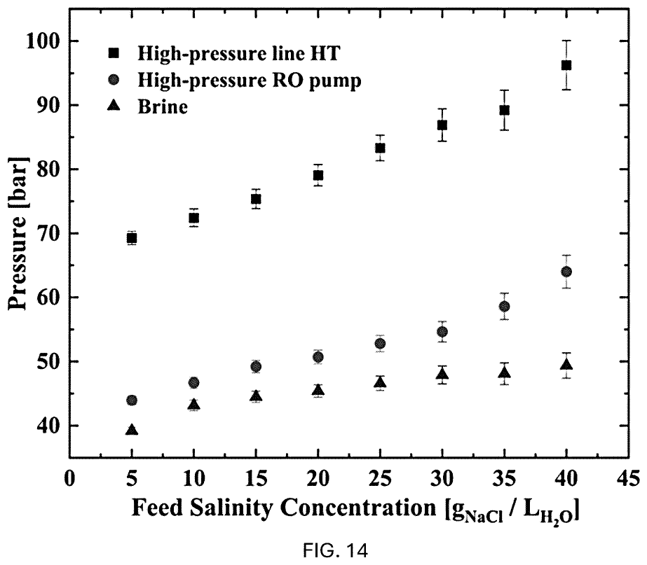

Referring to FIG. 14, a graph of experimental pressure in bar vs. feed salinity concentration

$$( \frac{{g}_{NaCl}}{{L}_{{H}_{2} O}} )$$

is provided which shows average pressure in time.

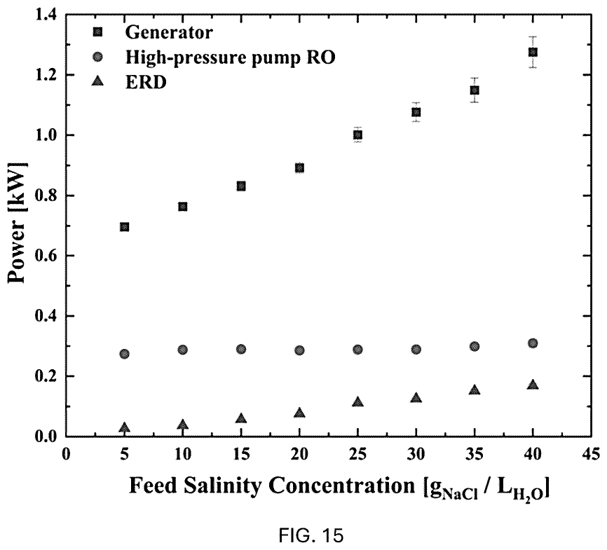

Referring to FIG. 15, a graph of experimental power in kW vs. feed salinity concentration

$$( \frac{{g}_{NaCl}}{{L}_{{H}_{2} O}} )$$

is provided which shows average power in time.

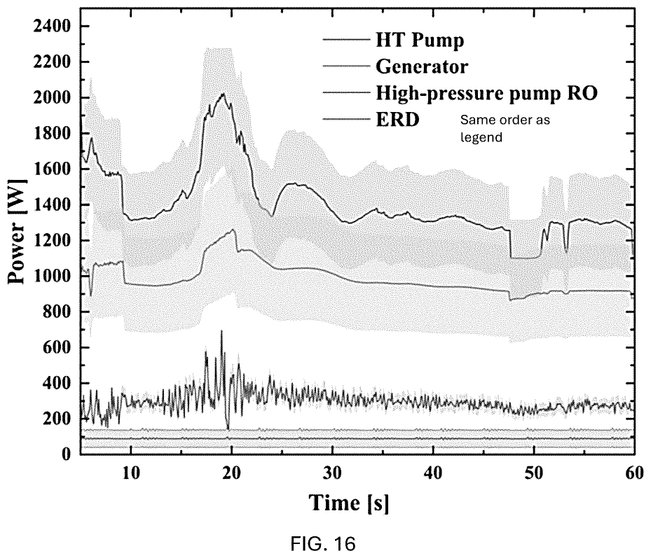

Referring to FIG. 16, a graph of experimental power in W vs. time in seconds is provided which shows instantaneous power in time.

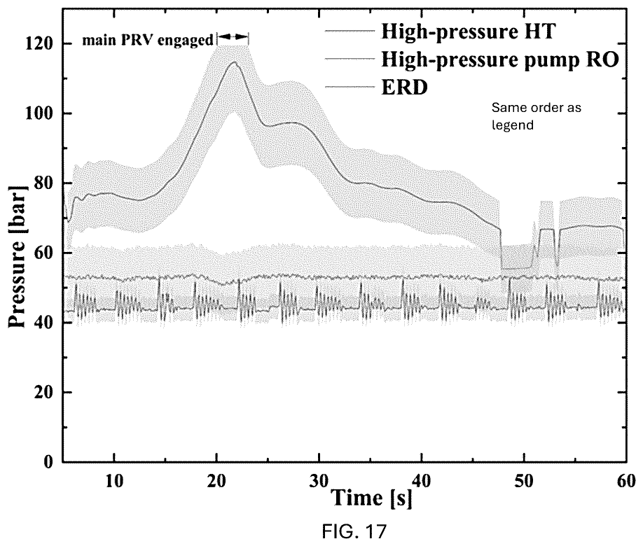

Referring to FIG. 17, a graph of experimental pressure in bar vs. time in seconds is provided which shows instantaneous pressure in time.

FIG. 18 is another schematic which depicts the controller scheme but this time with an artificial intelligence (AI) engine. This figure is similar to FIG. 2B, however, in this case the AI engine determines Kₚ, Kᵢ, and K_{d} by forecasting wind speed, wind direction, humidity, and temperature. As a result, the output of the AI engine (i.e., Kₚ, Kᵢ, and K_{d}) are all vary as a function of time based on the demand input and are no longer constants.

Referring to FIG. 19, another block diagram schematic of the system of the present disclosure, is provided. The nomenclature associated with each component is provided in Table 4. As in FIG. 18, the proportionality variables Kₚ, Kᵢ, and K_{d} are sourced from the AI engine and each is a function of time.

TABLE 6
Derivation of the proportionality constants Kₚ, Kᵢ, and K_{d}

For each controller j in {p, m1, m2}, the AI-updated PID gains are defined as:

| | |
|---|---|
| Kp_j(t) = clip(Kp_j0 + f_p,j(x_j(t)), Kp_j_min, Kp_j_max) | (A1) |
| Ki_j(t) = clip(Ki_j0 + f_i,j(x_j(t)), Ki_j_min, Ki_j_max) | (A2) |
| Kd_j(t) = clip(Kd_j0 + f_d,j(x_j(t)), Kd_j_min, Kd_j_max) | (A3) |

The clipping operator is defined as:

| | |
|---|---|
| clip(z, z_min, z_max) = min(max(z, z_min), z_max) | (A4) |

For the pump:
Pump loop error definition:

| | |
|---|---|
| e_p(t) = omega_r(t) − omega_r*(t) | (A5) |

AI input vector for the pump loop:
x_p(t) = [v_w, theta_w, dv_w/dt, omega_r, p_h, q_h, eta_HT, D_priority]\hat{ }T
Pump PID gain equations:

| | |
|---|---|
| Kp_p(t) = clip(Kp_p0 + f_p,p(x_p(t)), Kp_p_min, Kp_p_max) | (A6) |
| Ki_p(t) = clip(Ki_p0 + f_i,p(x_p(t)), Ki_p_min, Ki_p_max) | (A7) |
| Kd_p(t) = clip(Kd_p0 + f_d,p(x_p(t)), Kd_p_min, Kd_p_max) | (A8) |

```
Hence:
  Kp_p(t) = clip(Kp_p0 + a_p1*v_w_tilde + a_p2*|dv_w/dt|_tilde + a_p3*omega_r_tilde +
a_p4*p_h tilde + a p5*eta_HT_tilde) (A9)
  Ki_p(t) = clip(Ki_p0 + b_p1*v_w_tilde + b_p2*p_h_tilde + b_p3*q_h_tilde + b_p4*eta_HT_tilde)
(A10)
```

| | |
|---|---|
| Kd_p(t) = clip(Kd_p0 + c_p1*\|dv_w/dt\|_tilde + c_p2*omega_r_tilde + c_p3*p_h_tilde) | (A11) |

For the motor alfa2

| | |
|---|---|
| e_m1(t) = omega_g(t) − omega_g_star(t) | (A12) |

AI input vector for Motor 1:
x_m1(t) = [omega_g, P_e, P_e_star, p_h, q_m1, V_dc, lambda, eta_m1]\hat{ }T
Motor 1 PID gain equations:

| | |
|---|---|
| Kp_m1(t) = clip(Kp_m10 + f_p,m1(x_m1(t)), Kp_m1_min, Kp_m1_max) | (A13) |
| Ki_m1(t) = clip(Ki_m10 + f_i,m1(x_m1(t)), Ki_m1_min, Ki_m1_max) | (A14) |
| Kd_m1(t) = clip(Kd_m10 + f_d,m1(x_m1(t)), Kd_m1_min, Kd_m1_max) | (A15) |

```
Example explicit linearized form (optional implementation form):
Kp_m1(t) = clip(Kp_m10 + a_m11*omega_g_tilde + a_m12*|e_m1|_tilde + a_m13*p_h_tilde +
a_m14*lambda_tilde + a_m15*eta_m1_tilde) (A16)
  Ki_m1(t) = clip(Ki_m10 + b_m11*|e_m1|_tilde + b_m12*q_m1_tilde + b_m13*lambda_tilde)
(A17)
  Kd_m1(t) = clip(Kd_m10 + c_m11*|de_m1/dt|_tilde + c_m12*omega_g_tilde + c_m13*p_h_tilde)
(A18)
For the motor alfa3
Motor 2 loop error definition (pressure-based):
          Eq. (A19) e_m2(t) = p_RO(t) − p_RO_star(t)
AI input vector for Motor 2:
    x_m2(t) = [p_RO, Q_w, Q_w_star, S, T_w, p_h, q_m2, (1-lambda), eta_m2]\hat{ }T
Motor 2 PID gain equations:
```

| | |
|---|---|
| Kp_m2(t) = clip(Kp_m20 + f_p,m2(x_m2(t)), Kp_m2_min, Kp_m2_max) | (A20) |
| Ki_m2(t) = clip(Ki_m20 + f_i,m2(x_m2(t)), Ki_m2_min, Ki_m2_max) | (A21) |
| Kd_m2(t) = clip(Kd_m20 + f_d,m2(x_m2(t)), Kd_m2_min, Kd_m2_max) | (A22) |

Hence,
Kp_m2(t) = clip(Kp_m20 + a_m21*p_RO_tilde + a_m22*|e_m2|_tilde + a_m23*S_tilde + a_m24*(1-
lambda_tilde) + a_m25*eta_m2_tilde) (A23)
Ki_m2(t) = clip(Ki_m20 + b_m21*|e_m2|_tilde + b_m22*S_tilde + b_m23*Q_w_tilde + b_m24*(1-
lambda_tilde)) (A24)

| | |
|---|---|
| Kd_m2(t) = clip(Kd_m20 + c_m21*\|de_m2/dt\|_tilde + c_m22*p_RO_tilde + c_m23*p_h_tilde) | (A25) |

| Symbol | Description |
|---|---|
| u(t) | Generic control signal (PID output command) |
| e(t) | Generic control error |
| r(t) | Reference or setpoint |
| y(t) | Measured process variable |
| t | Time |
| \tau | Dummy integration time variable |
| de(t)/dt | Time derivative of error |
| K_p(t) | Proportional gain (time-varying, AI-tuned) |
| K_i(t) | Integral gain (time-varying, AI-tuned) |
| K_d(t) | Derivative gain (time-varying, AI-tuned) |
| K_p0, K_i0, K_d0 | Baseline or nominal PID gains |
| ΔK_p(t), ΔK_i(t), ΔK_d(t) | AI-based gain corrections |
| K_p, min, K_p, max | Minimum and maximum allowable proportional gain |
| K_i, min, K_i, max | Minimum and maximum allowable integral gain |
| K_d, min, K_d, max | Minimum and maximum allowable derivative gain |
| f_p(•), f_i(•), f_d(•) | AI/model functions for gain correction outputs |
| x(t) | General AI input or state vector |
| x_p(t) | AI input vector for pump displacement controller |
| x_m1(t) | AI input vector for motor 1 displacement controller |
| x_m2(t) | AI input vector for motor 2 displacement controller |
| clip(z, z_min, z_max) | Clipping operator that bounds z between lower and upper limits |
| sat_[0, 1](•) | Saturation operator limiting command to [0, 1] |
| z | Generic value being clipped |
| z_min, z_max | Lower and upper clipping limits |
| \beta_i(t) | Normalized displacement command for component i |
| D_i(t) | Actual volumetric displacement of component i |
| D_i, min | Minimum displacement of component i |
| D_i, max | Maximum displacement of component i |
| i | Component index |
| p | Variable-displacement hydraulic pump index |
| m1 | First variable-displacement hydraulic motor index |
| m2 | Second variable-displacement hydraulic motor index |
| e_p(t) | Pump-loop error for rotor loading control |
| \omega_r(t) | Wind rotor/pump shaft angular speed |
| \omega_r*(t) | Reference rotor speed (AI or MPPT generated) |
| K_p, p(t) | Pump-loop proportional gain |
| K_i, p(t) | Pump-loop integral gain |
| K_d, p(t) | Pump-loop derivative gain |
| K_p, p0, K_i, p0, K_d, p0 | Baseline pump-loop gains |
| K_p, p\hat{ }min, K_p, p\hat{ }max | Pump-loop proportional gain limits |
| K_i, p\hat{ }min, K_i, p\hat{ }max | Pump-loop integral gain limits |
| K_d, p\hat{ }min, K_d, p\hat{ }max | Pump-loop derivative gain limits |
| e_m1(t) | Motor 1 loop error, typically generator speed error |
| \omega_g(t) | Generator shaft angular speed (or motor 1 shaft speed) |
| \omega_g*(t) | Reference generator speed |
| P_e(t) | Electrical power output |
| P_e*(t) | Reference electrical power |
| K_p, m1(t) | Motor 1 proportional gain |
| K_i, m1(t) | Motor 1 integral gain |
| K_d, m1(t) | Motor 1 derivative gain |
| K_p, m10, K_i, m10, K_d, m10 | Baseline motor 1 gains |
| K_p, m1\hat{ }min, K_p, m1\hat{ }max | Motor 1 proportional gain limits |
| K_i, m1\hat{ }min, K_i, m1\hat{ }max | Motor 1 integral gain limits |
| K_d, m1\hat{ }min, K_d, m1\hat{ }max | Motor 1 derivative gain limits |
| e_m2(t) | Motor 2 loop error, typically RO pressure error |
| p_RO(t) | Reverse osmosis (or desalination feed) pressure |
| p_RO*(t) | Reference reverse osmosis feed pressure |
| Q_w(t) | Water production flow rate |
| Q_w*(t) | Reference water production flow rate |
| K_p, m2(t) | Motor 2 proportional gain |
| K_i, m2(t) | Motor 2 integral gain |
| K_d ,m2(t) | Motor 2 derivative gain |
| K_p, m20, K_i, m20, K_d, m20 | Baseline motor 2 gains |
| K_p ,m2\hat{ }min, K_p, m2\hat{ }max | Motor 2 proportional gain limits |
| K_i, m2\hat{ }min, K_i, m2\hat{ }max | Motor 2 integral gain limits |
| K_d, m2\hat{ }min, K_d, m2\hat{ }max | Motor 2 derivative gain limits |
| v_w(t) | Wind speed |
| \theta_w(t) | Wind direction |
| dv_w/dt | Time derivative of wind speed (gust intensity/wind acceleration) |
| T_a(t) | Ambient air temperature |
| RH(t) | Relative humidity |
| S(t) | Water salinity (feed salinity) |
| T_w(t) | Water/feed temperature |
| p_h(t) | Hydraulic line or system pressure |
| q_h(t) | Hydraulic flow rate (generic) |
| q_m1(t) | Hydraulic flow through motor 1 branch |
| q_m2(t) | Hydraulic flow through motor 2 branch |
| \eta_HT(t) | Estimated hydrostatic transmission efficiency |
| \eta_m1(t) | Estimated motor 1/generator branch efficiency |
| \eta_m2(t) | Estimated motor 2/water branch efficiency |
| D_priority(t) | Demand priority signal (water vs electricity emphasis) |
| \lambda(t) | AI-generated power split factor |
| P_avail(t) | Total available harvested power |
| P_e*(t) | Commanded power allocated to electricity branch |
| P_w*(t) | Commanded power allocated to water branch |
| V_dc(t) | DC bus voltage (if power electronics are present) |
| x^{~} | Normalized version of variable x |
| v_w^{~} | Normalized wind speed |
| \|dv_w/dt\|^{~} | Normalized absolute wind acceleration |
| ω_r^{~} | Normalized rotor speed |
| ω_g^{~} | Normalized generator speed |
| p_h^{~} | Normalized hydraulic pressure |
| q_h^{~} | Normalized hydraulic flow |
| p_RO^{~} | Normalized RO pressure |
| Q_w^{~} | Normalized water production flow |
| S^{~} | Normalized salinity |
| η_HT^{~}, η_m1^{~}, η_m2^{~} | Normalized efficiencies |
| \lambda^{~} | Normalized power split factor |
| \|e_m1\|^{~}, \|e_m2\|^{~} | Normalized absolute loop errors |
| \|de_m1/dt\|^{~}, \|de_m2/dt\|^{~} | Normalized absolute error derivatives |
| j | Controller-loop index |
| K_p, j(t), K_i, j(t), K_d, j(t) | PID gains for loop j |
| x_j(t) | AI input vector for loop j |
| k | Discrete-time sample index |
| n | Summation index in discrete integral term |
| [k] | Value evaluated at sample k |
| \Delta t | Controller sampling period |
| e[k] | Discrete-time control error |
| K_p[k], K_i[k], K_d[k] | Discrete-time PID gains |
| Symbol | Description |
| \beta_i[k] | Discrete-time normalized displacement command |
| D_i[k] | Discrete-time actual displacement |
| I_j(t) | Integral state for controller loop j |
| dl_j/dt | Time derivative of integral state |
| d_j(t) | Filtered derivative signal for loop j |
| dd_j/dt | Time derivative of filtered derivative state |
| \tau_d, j | Derivative filter time constant for loop j |
| r_i\hat{ }max | Maximum allowable rate of change of\beta_i |

It should be appreciated that the controller discussed herein includes one or more processors and one or more non-transient memories, wherein the one or more processors are configured to execute software maintained in the one or more non-transient memories in order to receive signals from the suite of sensors and provide outputs to control the variable displacement hydraulic pump 206 (see FIG. 2A), the variable displacement hydraulic motor 224 (see FIG. 2A) that is coupled to the electrical generator 36 (see FIG. 1), the variable displacement hydraulic motor 226 (see FIG. 2A) which is coupled to the high-pressure-pump 42 (see FIG. 1), and the proportional throttle valve 228 (see FIG. 2A).

Additionally, while a wind turbine 22 (see FIG. 1) as the prime mover, other approaches may be implemented, e.g., an electric motor powered by an electrical source, e.g., a solar cell network, an internal combustion engine, wave energy devices, or other energy capture devices, known to a person having ordinary skill in the art.

It should also be noted that more than one prime mover can be implemented. For example, an internal combustion engine and a wind turbine can be implemented together. Thus, when there is substantially no wind, the controller discussed herein or another external controller, can switch between the wind turbine and the internal combustion engine. Alternatively, both prime movers can be running at the same time using one or more clutches. Therefore, when more than one prime mover is chosen, the prime movers can be dynamically selected one at a time or more than one operating at the same time.

Those having ordinary skill in the art will recognize that numerous modifications can be made to the specific implementations described above. The implementations should not be limited to the particular limitations described. Other implementations may be possible.

1. A system capable of simultaneously purifying water and generating electricity, comprising:
one or more prime mover adapted to provide a rotational movement of a pump output shaft;
a variable displacement hydraulic pump coupled to the pump output shaft, wherein the variable displacement hydraulic pump controls flow of a fluid from its low-pressure side to its high-pressure side by a pump plate controlled by a pump control signal;
a first variable displacement hydraulic motor hydraulically coupled to the variable displacement hydraulic pump, wherein the first variable displacement hydraulic motor controls flow of the fluid from its low-pressure side to its high-pressure side by a first motor plate controlled by a first motor control signal, thus adapted to generate rotational movement of a first motor output shaft;
a second variable displacement hydraulic motor hydraulically coupled to the variable displacement hydraulic pump, wherein the second variable displacement hydraulic motor controls flow of the fluid from its low-pressure side to its high-pressure side by a second motor plate controlled by a second motor control signal, thus adapted to generate rotational movement of a second motor output shaft; and
a controller having one or more processors adapted to execute software maintained in one or more non-transient memories, the controller adapted to generate a plurality of control signals, comprising:
the pump control signal,
the first motor control signal, and
the second motor control signal,
wherein the first motor output shaft is adapted to be coupled to an electrical generator to thereby generate electricity, and
wherein the second motor output shaft is adapted to be coupled to a water purification pump to draw unpure water from a feed supply and provide the unpure water to a water purification system to thereby generate permeated water and separated impurities.

2. The system capable of simultaneously purifying water and generating electricity of claim 1, wherein the fluid is a hydraulic fluid.

3. The system capable of simultaneously purifying water and generating electricity of claim 1, wherein the one or more prime movers is selected from the group consisting of one or more wind turbines, a solar cell network including a motor, one or more wave energy converters, one or more internal combustion engines, and combinations thereof.

4. The system capable of simultaneously purifying water and generating electricity of claim 3, wherein when more than one prime mover is selected, the one or more prime movers are coupled to one another via one or more clutches.

5. The system capable of simultaneously purifying water and generating electricity of claim 3, wherein when more than one prime mover is selected, the prime movers automatically switch from one prime mover to another prime mover, or automatically integrate power from more than one prime mover to rotate the pump output shaft.

6. The system capable of simultaneously purifying water and generating electricity of claim 1, wherein the water purification system is a reverse osmosis system having a membrane.

7. The system capable of simultaneously purifying water and generating electricity of claim 1, wherein the controller utilizes a plurality of parameters to generate the plurality of control signals.

8. The system capable of simultaneously purifying water and generating electricity of claim 7, wherein the plurality of parameters include:
one or more parameters associated with the prime mover;
output flow rate of the fluid exiting the high-pressure side of the variable displacement hydraulic pump;
difference in pressure of the high-pressure side and low-pressure side of the variable displacement hydraulic pump,
a flow rate associated with a high-pressure side of the water purification pump, a flow rate associated with flow of the permeated water,
a flow rate associated with flow of the impurities,
an angular velocity of the electrical generator,
power generated by the electrical generator, and
a resource demand schedule for the generated permeated water by the water purification system and the generated electricity by the electrical generator.

9. The system capable of simultaneously purifying water and generating electricity of claim 1, further comprising:
a proportional throttle valve disposed between the high-pressure side of the first variable displacement hydraulic motor and the high-pressure side of the second variable displacement hydraulic motor, wherein the proportional throttle valve apportions the fluid received by the first and second variable displacement hydraulic motors based on a proportional throttle valve control signal included in the plurality of control signals, wherein the proportional throttle valve control signal is generated by the controller.

10. The system capable of simultaneously purifying water and generating electricity of claim 9, wherein the controller includes an artificial intelligence engine adapted to forecast parametric conditions of the prime mover and in real-time adjust the plurality of control signals based on said forecasting.

11. A method of simultaneously purifying water and generating electricity, comprising:
receiving rotational movement from a pump output shaft of one or more prime movers;
coupling a variable displacement hydraulic pump coupled to the pump output shaft, wherein the variable displacement hydraulic pump controls flow of a fluid from its low-pressure side to its high-pressure side by a pump plate controlled by a pump control signal;
hydraulically coupling a first variable displacement hydraulic motor to the variable displacement hydraulic pump, wherein the first variable displacement hydraulic motor controls flow of the fluid from its low-pressure side to its high-pressure side by a first motor plate controlled by a first motor control signal, thus adapted to generate rotational movement of a first motor output shaft;
hydraulically coupling a second variable displacement hydraulic motor to the variable displacement hydraulic pump, wherein the second variable displacement hydraulic motor controls flow of the fluid from its low-pressure side to its high-pressure side by a second motor plate controlled by a second motor control signal, thus adapted to generate rotational movement of a second motor output shaft; and
controlling a plurality of control signals by a controller having one or more processors adapted to execute software maintained in one or more non-transient memories, the plurality of control signals, comprising:
the pump control signal,
the first motor control signal, and
the second motor control signal,
wherein the first motor output shaft is adapted to be coupled to an electrical generator to thereby generate electricity, and
wherein the second motor output shaft is adapted to be coupled to a water purification pump to draw unpure water from a feed supply and provide the unpure water to a water purification system to thereby generate permeated water and separated impurities.

12. The method of claim 11, wherein the fluid is a hydraulic fluid.

13. The method of claim 11, wherein the one or more prime movers is selected from the group consisting of one or more wind turbines, a solar cell network including a motor, one or more wave energy converters, one or more internal combustion engines, and combinations thereof.

14. The method of claim 3, wherein when more than one prime mover is selected, the one or more prime movers are coupled to one another via one or more clutches.

15. The method of claim 3, wherein when more than one prime mover is selected, the prime movers automatically switch from one prime mover to another prime mover, or automatically integrate power from more than one prime mover to rotate the pump output shaft.

16. The method of claim 11, wherein the water purification system is a reverse osmosis system having a membrane.

17. The method of claim 11, wherein the controller utilizes a plurality of parameters to generate the plurality of control signals.

18. The method of claim 17, wherein the plurality of parameters include:
one or more parameters associated with the prime mover;
output flow rate of the fluid exiting the high-pressure side of the variable displacement hydraulic pump;
difference in pressure of the high-pressure side and low-pressure side of the variable displacement hydraulic pump,
a flow rate associated with a high-pressure side of the water purification pump,
a flow rate associated with flow of the permeated water,
a flow rate associated with flow of the impurities,
an angular velocity of the electrical generator,
power generated by the electrical generator, and
a resource demand schedule for the generated permeated water by the water purification system and the generated electricity by the electrical generator.

19. The method of claim 11, further comprising:
apportioning the fluid received by the first and second variable displacement hydraulic motors by a proportional throttle valve disposed between the high-pressure side of the first variable displacement hydraulic motor and the high-pressure side of the second variable displacement hydraulic motor, wherein said apportioning is based on a proportional throttle valve control signal included in the plurality of control signals, wherein the proportional throttle valve control signal is generated by the controller.

20. The method of claim 19, wherein the controller includes an artificial intelligence engine adapted to forecast parametric conditions of the prime mover and in real-time adjust the plurality of control signals based on said forecasting.
